(19) United States
(12) Patent Application Publication
(10) Pub. No.: US 2026/0186612 A1
(43) Pub. Date: Jul. 2, 2026

(54) AUTOMATED DATA CLASSIFICATION FOR COLLABORATION PLATFORMS

(71) Applicant: Atlassian Pty Ltd., Sydney (AU)

(72) Inventors: Bo Wang, Santa Clara, CA (US); Dhanraj Jadhav, Union City, CA (US); Jeremy Chen, New York, NY (US); Avinoam Zelenko, Parkland, FL (US)

(21) Appl. No.: 19/007,219

(22) Filed: Dec. 31, 2024

(51) Int. Cl. G06F 3/0481; G06N 3/0455; G06N 3/0475

(52) U.S. Cl. CPC G06F 3/0481; G06N 3/0455; G06N 3/0475

(57) ABSTRACT

Methods and systems for automated data classification for collaboration platforms are described. The method may include, building and deploying automation rules with one or both of a classification trigger component or a classification action component. For a classification trigger component, a change in classification of an electronic document via an event may be detected. An automation rule may then be run based on the detection, where one or more actions of the automation rule may be performed. For a classification action component, an automation rule may be triggered, and one or more action components of the automation rule are run. A classification action component may operate to change the classification of an electronic document of the collaboration system.

### TECHNICAL FIELD

Embodiments described herein relate to multi-tenant services of collaborative work environments and, in particular, to systems and methods for automated data classification for collaboration platforms.

### BACKGROUND

An organization can establish a collaborative work environment by self-hosting, or providing its employees with access to, a suite of discrete software platforms or services to facilitate cooperation and completion of work. In many cases, the organization may also define policies outlining best practices for interacting with, and organizing data within, each software platform of the suite of software platforms.

Often internal best practice policies require employees to thoroughly document completion of tasks, assignment of work, decision points, and so on. Such policies additionally often require employees to structure and format documentation in particular ways, to copy data or status information between multiple platforms at specific times, or to perform other rigidly defined, policy-driven, tasks. These requirements are both time and resource consuming for employees, reducing overall team and individual productivity.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system that includes a centralized automation rule service for the creation of automation rules.

FIG. 2 depicts an example frontend interface, according to one or more aspects described herein.

FIG. 3 depicts an example frontend interface, according to one or more aspects described herein.

FIG. 4 depicts an example frontend interface, according to one or more aspects described herein.

FIG. 5 depicts an example frontend interface, according to one or more aspects described herein.

FIG. 6 depicts an example frontend interface, according to one or more aspects described herein.

FIG. 7 depicts an example frontend interface, according to one or more aspects described herein.

FIG. 8 depicts an example frontend interface, according to one or more aspects described herein.

FIG. 9 depicts an example frontend interface, according to one or more aspects described herein.

FIG. 10 depicts an example frontend interface, according to one or more aspects described herein.

FIG. 11 depicts an example frontend interface, according to one or more aspects described herein.

FIG. 12 depicts an example method for automated data classification within a collaboration system, according to one or more aspects described herein.

FIG. 13 depicts another example method for automated data classification within a collaboration system, according to one or more aspects described herein.

FIG. 14 depicts another example method for automated data classification within a collaboration system, according to one or more aspects described herein.

FIG. 15 depicts another example method for automated data classification within a collaboration system, according to one or more aspects described herein.

FIG. 16A depicts a simplified diagram of a system, such as described herein that can include and/or may receive input from a generative output engine.

FIG. 16B depicts a functional system diagram of a system that can be used to implement a multiplatform prompt management service.

FIG. 17A depicts a simplified system diagram and data processing pipeline.

FIG. 17B depicts a system providing multiplatform prompt management as a service.

FIG. 18 depicts a sample electrical block diagram of an electronic device that may perform the operations described herein.

### DETAILED DESCRIPTION

Embodiments described herein relate to systems, devices, and methods for automatically generating rules for collaboration platforms, such as documentation systems, issue tracking systems, project management platforms, and the like.

Collaboration platforms can be used to generate, store, and organize user-generated content. As described herein, a collaboration platform or service may include an editor that is configured to receive user input and generate user-generated content that is saved as a content item. The terms “collaboration platform” or “collaboration service” may be used to refer to a documentation platform, service, or system configured to manage electronic documents or pages created by the system users, an issue tracking platform, service, or system that is configured to manage or track issues or tickets in accordance with an issue or ticket workflow, a source code management platform, service, or system that is configured to manage source code and other aspects of a software product, or a manufacturing resource planning platform, service, or system configured to manage inventory, purchases, sales activity or other aspects of a company or enterprise. The examples provided herein are described with respect to an editor that is integrated with the collaboration platform. In some instances, the functionality described herein may be adapted to multiple platforms or adapted for cross-platform use through the use of a common or unitary editor service. For example, the functionality described in each example is provided with respect to a particular collaboration platform, but the same or similar functionality can be extended to other platforms by using the same editor service. Also, as described above a set of host services or platforms may be accessed through a common gateway or using a common authentication scheme, which may allow a user to transition between platforms and access platform-specific content without having to enter user credentials for each platform.

An automation rule (which may also be referred to as “automated rules,” or simply “rules”) is an automated workflow that is generally constructed in a “if this, then that” format. Typically, for example in a collaboration platform, an automation rule results in the performance of an action upon the occurrence of a trigger, if certain conditions are met. In a collaboration platform, each automation rule is made by combining different types of components, including triggers and actions. An automation rule typically also includes a condition. Branches may also be used in some cases. As used herein, automation rules begin with a trigger (which may also be referred to as a trigger component, trigger criteria), the trigger being the catalyst that sets the execution of a rule in motion. In one or more embodiments, a condition (which may also be referred to as a condition component) may also be used, where the condition is a limit on the scope of the automation rule. For example, a condition may require that the rule may only be run when the action that initiated the trigger was performed by a certain user or group of users. As used herein, an action (or action component) is what the rule does or performs, for example what happens when the trigger (and conditions if applicable) is met. In some embodiments, an automation rule may also include a branch. A branch expands the performance or execution of a rule by adding a secondary path (a branch). As used herein, a branch is a sequence of conditions and/or actions that run in isolation from the rest of the rule, but are applied to each (e.g., every) instance of an object. For example, the rule for each task (e.g., an object) can be branched so that a message is sent to a recipient every time a person is mentioned on a particular page (e.g., when such page is published). This branch action occurs in addition to any action on the primary path of the automation rule chain.

In some cases, a collaboration platform may include a large amount of user or content to be managed. Certain tasks may require many repetitive actions, or a person responsible for managing content may not realize that an action needs to be performed to manage the content. As such, a collaboration platform may benefit from allowing users to establish automation rules to automatically perform such tasks that would otherwise need to be performed manually. Such automation rules can reduce management overhead, saving time and freeing up resources, and add management consistency, increasing transparency and organization, while reducing errors.

Additionally, collaboration systems may use one or more content classification systems for the content of each collaboration platform. For example, a document management platform may use a document classification system relevant to the content of the document management system. An issue tracking platform may similarly use a classification system for the content of issues and tasks of the issue. In some cases, the content classification systems may be consistent across the collaboration platforms of the system, such that similar or the same classifications may be applied, even across disparate types of content. In some cases, a security service may be used to manage the classifications of content in reference to different users and groups of the collaboration systems.

Content classification systems are essential tools for organizing and managing information based on its sensitivity, confidentiality, and intended audience. The use of different classifications (which may also be referred to as content categories, classification levels, or security levels) provide a structured approach to handling content such as documents and issues, and ensuring appropriate access and security measures are applied for users and groups. These content classification systems serve several purposes, including access control, regulatory compliance, risk mitigation, efficient information management, and facilitating secure data sharing and collaboration. For example, public content may be accessible to everyone, while restricted or confidential documents may be limited to authorized individuals to prevent unauthorized access and potential breaches. As further discussed here, such classification systems may use multiple different classification levels. An organization utilizing a content collaboration system may establish its own content classification system, including different levels having different access and security properties.

One example of a content classification system of an organization may include classifications, from relatively more restrictive to relatively less restrictive, that include the classifications of “restricted” (most restrictive), “protected,” “confidential,” “internal,” and “public” (least restrictive). A “restricted” classification may include content or data that would be very damaging to the organization, cause loss of trust with customers, and/or present legal risk to the organization if mishandled. A “protected” classification may include content or data that could cause a loss of trust with customers and/or present legal risk to the organization if mishandled, but would not be as damaging as “restricted” content. A “confidential” classification may include content or data that would likely be damaging and could cause loss of trust with customers, but likely not present legal risk to the organization if mishandled. An “internal” classification may include content or data that could be potentially damaging to customers and/or the organization, but less so than restricted, protected, or confidential content or data. A “public” classification may include content or data that is freely available to the public, without restriction, because it presents no legal or reputational risk to the organization or its customers.

There may be several benefits of implementing content classification systems. Enhanced security is an advantage, as organizations can tailor protections to the sensitivity of each content category, such as encrypting protected documents or restricting access to confidential files to particular users or groups of the collaboration system. Clear classifications also improve decision-making, allowing stakeholders to assess quickly which information can be shared and what must remain secure. Operational efficiency may be another benefit, as users can rely on predefined guidelines to handle documents appropriately, saving time and reducing administrative burdens. Robust classification practices can build trust with customers and partners by demonstrating a commitment to safeguarding sensitive information.

Moreover, organizations may focus resources on protecting more highly sensitive documents, such as restricted, protected, or confidential content, while applying lighter controls to less critical categories like public or internal content. In the event of a security incident, a robust classification system may simplify the identification of affected materials, enabling a more targeted and efficient response.

An organization using a content collaboration system may desire to effectively and efficiently manage the classification of their content classification systems. As further described herein, automation rules may be used in connection with the content classification system to more efficiently manage costs and resource allocation.

In one example, a classification trigger component is described. The classification trigger component may be defined and incorporated into an automation of the collaboration system. The classification trigger component may be defined in a rule builder via a trigger modification window that includes an input field to indicate a classification level change for an electronic document associated with the classification trigger component. One or more action components (and optionally other automation rule components) may then be specified for the automation rule, and a service generated on the collaboration system corresponding to the automation rule that includes the classification trigger component. In other words, the classification trigger component may be used to provide trigger criteria in connection with a content classification. When an event is detected that changes a classification level, operations corresponding to the action components may then be performed in the collaboration system in response.

In another example, a classification action component is described. Similar to the classification trigger component, the classification action component may be defined and incorporated into an automation of the collaboration system. The classification action component may be defined in a rule builder via an action modification window that includes an input field to indicate a classification level for an electronic document associated with the classification action component. For example, the classification level of the classification action component may be the new classification level for a content item, which previously may have had an old classification level, or no classification level. The classification action component may be triggered from any suitable action component, including from a classification trigger component, and may be a part of an automation rule that includes other (not-classification) action components. Once the automation rule has the classification action component is configured and specified, a service may be generated on the collaboration system corresponding to the automation rule that includes the classification action component. As such, the classification action component may be used to modify or provide a classification level for content associated with an object on a collaboration platform, such as an electronic document. When an event is detected according to the trigger criteria of the automation rule, operations corresponding to the classification action component may then be performed in the collaboration system in response, modifying or providing the classification level, according to the classification action component.

In one or more embodiments, an automation rule may use a generative output engine (e.g., which may use or be referred to as Atlassian intelligence (AI) in some cases), and an automation rule triggered by a user group trigger may perform an action that invokes, calls to, or otherwise uses a generative output engine.

### Scalable Network Architecture for Automatic Content Generation

More specifically, systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding.

In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples).

In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input. Many of the examples described herein are directed to an interface that includes a generative interface panel having an input region that can receive commands, references to content, links, and other input, at least a portion of which is provided as natural language text.

In some examples, the user may engage with a button in a UI that causes the generative interface panel or a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands-after the user types a slash character, any text input after the slash character can be considered as a command to instruct the underlying system to perform a task.

Regardless of how a software platform user interface is instrumented to receive user input, the user may provide an input that includes a string of text including a natural language request or instruction (e.g., a prompt). The prompt may be provided as input to an input queue including other requests from other users or other software platforms. Once the prompt is popped from the queue, it may be normalized and/or preconditioned by a preconditioning service. The preconditioning service may be provided by one or more registered plugins that are selected in accordance with an analysis of the input and/or context of the current session.

The preconditioning service can, without limitation: append additional context to the user's raw input; may insert the user's raw input into a template prompt selected from a set of prompts; replace ambiguous references in the user's input with specific references (e.g., replace user-directed pronouns with user IDs, replace @mentions with user IDs, and so on); correct spelling or grammar; translate the user input to another language; or perform other operations. Thereafter, optionally, the modified/supplemented/hydrated user input can be provided as input to a secondary queue that meters and orders requests from one or more software platforms to a generative output system, such as described herein. The generative output system receives, as input, a modified prompt and provides a continuation of that prompt as output which can be directed to an appropriate recipient, such as the graphical user interface operated by the user that initiated the request or such as a separate platform. Many configurations and constructions are possible.

### Large Language Models

An example of a generative output engine of a generative output system as described herein may be a large language model (LLM). An LLM may include a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. An LLM is typically trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation, and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation can be selected or generated using a number of techniques. In many cases, a continuation of an input prompt may be referred to more generally as “generated text” or “generated output” provided by a generative output engine as described herein.

Fundamentally all written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation. In addition, because punctuation and whitespace can serve as a portion of training data, the generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt. For example, a prompt of “what is the syntax for a while loop in C and how does it work” may be continued by an LLM by providing, in addition to an explanation in natural language, a C++ compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href=‘https://example link/123456>project 123456</a>”. In addition, the LLM may be configured to replace the substring “pending” with a real-time updating token associated with an API call to the project management system. In this manner, the LLM converts a static string within the document management system into richer content that facilitates convenient and automatic cross-linking between software products, and may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilities bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### Transformer Architecture

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of attention mechanisms, including self-attention mechanisms, may be suitable.

In response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations. In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output suitably continues the input prompt, contains offensive language or tone, provides a continuation misaligned with typical human values, and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### Generative Output Engines & Generative Output Systems

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoints, such as for configuration or for receiving input prompts. The generative output application can be further configured to provide generated text output to one or more subscribers or API clients. Many suitable interfaces can be configured to provide input to and to receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:
{
“prompt”: “Generate five words of placeholder text in the English language.”,
“API_KEY”: “hx-Y5u4zx3kaF67AzkXK1hC”,
“user_token”: “PkcLe7Co2G-50AoIVojGJ”
}

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:
{
“response”:“Hello world text goes here.”,
“generation_time_ms”:2
}

In some embodiments, a prompt provided as input to a generative output engine can be engineered from user input. For example, in some cases, a user input can be inserted into an engineered template prompt that itself is stored in a database. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### Prompt Pre-Configuration, Templatizing, & Engineering

As noted above, a prompt received from a user can be preconditioned and/or parsed to extract certain content therefrom. The extracted content can be used to inform selection of a particular engineered prompt template from a database of engineered prompt templates. Once the selected prompt template is selected, the extracted content can be inserted into the template to generate a populated engineered prompt template that, in turn, can be provided as input to a generative output engine as described herein. Content extraction, prompt configuration, and prompt selection may be performed by a processing plugin that is registered or otherwise available to a generative service.

In many cases, a particular engineered prompt template can be selected based on a desired task for which output of the generative output engine may be useful to assist. For example, if a user requires a summary of a particular document, the user input prompt may be a text string comprising the phrase “generate a summary of this page.” A software instance configured for prompt preconditioning—which may be referred to as a “preconditioning software instance,” “prompt preconditioning software instance,” “processing plugin,” or “plugin”—may perform one or more substitutions of terms or words in this input phrase, such as replacing the demonstrative pronoun phrase “this page” with an unambiguous unique page ID. In this example, preconditioning software instance can provide an output of “generate a summary of the page with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences.

For example, in an embodiment, the preconditioning software instance can insert a phrase that adds contextual information describing the user making the initial input and request. In this example, output of the prompt preconditioning instance may be “generate a summary of the page with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information” or “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports, and so on. For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated to the user. Similarly, the “home page in my personal space” can be replaced, contextually, with a page identifier that corresponds to that user's personal space and the page that serves as the homepage thereof. Additionally, the preconditioning instance can replace the referenced time window in the raw input prompt based on the current date and based on a calculated date two weeks in the future. With these two modifications, the modified input prompt may be “generate a table of the tasks assigned to User 1234 dating from Jan. 1, 2023-Jan. 14, 2023 (inclusive), and insert the generated table into page 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of: “summarize the edits to this page made by my team since I last visited this page” could determine the user's ID, team members with close connections to that user based on a user graph, determine that the user last visited the page three weeks prior, and filter attribution of edits within the last three weeks to the current page ID based on those team members. With these modifications, the prompt provided to the generative output engine may be:
{
   “raw_prompt”:summarize the edits to this page made by my team since I last visited this page”,
   “modified_prompt”:“Generate a summary of each paragraph tagged with an editId attribute matching editId=1, editId=51, editId=165, editId=99 within the following HTML-formatted content: [HTML-formatted content of the page].”
}

Similarly, the preconditioning service may utilize a project graph, issue graph, or other data structure that is generated using edges or relationships between system objects that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:
{
   “snippet123_table_from_tasks”:“The table should be formatted as a three-column table with multiple rows. The leftmost column should be titled ‘Title’ and the corresponding content of each row of this column should be the title attribute of a task. The middle column should be titled ‘Created Date’ and the corresponding content of each row of this column should be the creation date of the task. The rightmost column should be titled ‘Status’ and the corresponding content of each row of this column should be the status attribute of the selected task.”
}

The foregoing examples of modifications and supplements to user input prompt are not exhaustive. Other modifications are possible. In one embodiment, the user input of “generate a table of all my tasks for the next two weeks” may be converted, supplemented, modified, and/or otherwise preconditioned to:
{
   “modified_prompt”:“Find all tasks assigned to User 1234 dating from Jan. 1, 2023-Jan. 14, 2023 (inclusive). Create a table in which each found task corresponds to a respective row of that table. The table should be formatted as a markdown table, in plain text, with three columns. The leftmost column should be titled ‘Title’ and the corresponding content of each row of this column should be the title attribute of a respective task. The middle column should be titled ‘Created Date’ and the corresponding content of each row of this column should be the creation date of the respective task. The rightmost column should be titled ‘Status’ and the corresponding content of each row of this column should be the status attribute of the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents.

In yet other examples, staging of requests may be useful for other purposes.

### Authentication & Authorization

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In some cases, a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile. The prompt engineering service may also verify or validate links that are referenced in the prompt from which prompt content is extracted before the prompt is provided to the generative output engine. Specifically, the prompt engineering service or another software instance can be configured to iterate through each link to determine (1) whether the link is valid, and (2) whether the requesting user has permission and authorization to view content at the link. If either test fails, the prompt generation may be interrupted or canceled and/or an error message may be displayed to the user.

In other embodiments, a prompt engineering service may be configured to request that the generative output engine append citations (e.g., back links) to each page or source from which information in a generative response was based. In these examples and as described above, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url.”

In yet other examples, a prompt engineering service may be configured to classify a user input into one of a number of classes of requests. Different classes of requests may be associated with different permissions handling techniques. For example, a class of request that requires a generative output engine to resource from multiple pages may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein. More generally, as noted above, a generative output engine may be a portion of a larger network and communications architecture as described herein. This network can include input queues, prompt constructors, engine selection logical elements, request routing appliances, authentication handlers and so on.

### Collaboration Platforms Integrated With Generative Output Systems

In particular, embodiments described herein are focused to leveraging generative output engines to produce content in a software platform used for collaboration between multiple users, such as documentation tools, issue tracking systems, project management systems, information technology service management systems, ticketing systems, repository systems, telecommunications systems, messaging systems, and the like, each of which may define different environments in which content can be generated by users of those systems. For example, a documentation system may define an environment in which users of the documentation system can leverage a user interface of a frontend of the system to generate documentation in respect of a project, product, process, or goal. For example, a software development team may use a documentation system to document features and functionality of the software product. In other cases, the development team may use the documentation system to capture meeting notes, track project goals, and outline internal best practices.

Other software platforms store, collect, and present different information in different ways. For example, an issue tracking system may be used to assign work within an organization and/or to track completion of work, a ticketing system may be used to track compliance with service level agreements, and so on. Any one of these software platforms or platform types can be communicably coupled to a generative output engine, as described herein, in order to automatically generate structured or unstructured content within environments defined by those systems. For example, a documentation system can leverage a generative output engine to, without limitation: summarize individual documents; summarize portions of documents; summarize multiple selected documents; generate document templates; generate document section templates; generate suggestions for cross-links to other documents or platforms; generate suggestions for adding detail or improving conciseness for particular document sections; and so on.

More broadly, it may be appreciated that a single organization may be a tenant of multiple software platforms, of different software platform types. Generally, and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multitenant software platform.

For simplicity of description, the multitenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform—multitenant or otherwise—as described herein are not collocated, and communicate over a large area and/or wide area network by leveraging one or more networking protocols, but this is not required of all implementations.

A frontend of a software platform as described herein may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multitenant software platform. In many embodiments, as noted above, tenant-owned content may be stored, transmitted, and/or formatted for display by a frontend of a software platform as structured data. In particular structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third-party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multitenant software and, in particular, by a provider of suites of multitenant software platforms, each platform being configured for a different particular purpose. Herein, providers of systems or suites of multitenant software platforms are referred to as “multiplatform service providers.” Generally, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multitenant issue tracking system, a multitenant code repository service, and a multitenant documentation service. In this example, an organization that is a customer/client of the service provider may be a tenant of each of the issue tracking system, the code repository service, and the documentation service.

As with preceding examples, the organization can create and/or purchase user accounts for its employees, so that certain selected employees have access to one or more of issue tracking functionality, documentation functionality, and code repository functionality.

In this example and others, a system may leverage multiple collaboration tools to advance individual projects or goals. For example, for a single software development project, a software development team may use (1) a code repository to store project code, executables, and/or static assets, (2) a documentation service to maintain documentation related to the software development project, (3) an issue tracking system to track assignment and progression of work, and (4) a messaging service to exchange information directly between team members.

However, as organizations grow, as project teams become larger, and/or as software platforms mature and add features or adjust user interaction paradigms over time, using multiple software platforms can become inefficient for both individuals and organizations. To counteract these effects, many organizations define internal policies that employees are required to follow to maintain data freshness across the various platforms used by an organization.

For example, when a developer submits a new pull request to a repository service, that developer may also be required by the organization to (1) update a description of the pull request in a documentation service, (2) change a project status in a project management application, and/or (3) close a ticket in a ticketing or issue tracking system relating to the pull request. In many cases, updating and interacting with multiple platforms on a regular and repeating basis is both frustrating and time consuming for both individuals and organizations, especially if the completion of work of one user is dependent upon completion of work of another user.

Some solutions to these and related problems often introduce further issues and complexity. For example, many software platforms include an in-built automation engine that can expedite performance of work within that software platform. In many cases, however, users of a software platform with an in-built automation engine may not be familiar with the features of the automation engine, nor may those users understand how to access, much less efficiently utilize, that automation engine. For example, in many cases, accessing in-built automation engines of a software platform requires diving deep into a settings or options menu, which may be difficult to find.

Other solutions involve an inter-platform bridge software that allows data from one platform to be accessed by another platform. Typically, such bridging software is referred to as an “integration” between platforms. An integration between different platforms may allow content, features, and/or functionality of one platform to be used in another platform.

For example, a multiplatform service provider may host an issue tracking system and a documentation system. The provider may also supply an integration that allows issue tracking information and data objects to be shown, accessed, and/or displayed from within the documentation system. In this example, the integration itself needs to be separately maintained in order to be compliant with an organization's data sharing and/or permissions policies. More specifically, an integration must ensure that authenticated users of the documentation system that view a page that references information stored by the issue tracking system are also authorized to view that information by the issue tracking system.

Phrased in a more general way, an architecture that includes one or more integrations between tenancies of different software platforms requires multiple permissions requests that may be forwarded to different systems, each of which may exhibit different latencies, and have different response formats, and so on. More broadly, some system architectures with integrations between software platforms necessarily require numerous network calls and requests, occupying bandwidth and computational resources at both software platforms and at the integration itself, to simply share and request information and service requests for information by and between the different software platforms. This architectural complexity necessitates careful management to prevent inadvertent information disclosure.

Furthermore, the foregoing problem(s) with maintaining integrations' compliance with an organization's policies and organization-owned content access policies may be exacerbated as a provider's platform suite grows. For example, a provider that maintains three separate platforms may choose to provide three separate integrations interconnecting all three platforms (e.g., 3 choose 2). In this example, the provider is also tasked with maintaining policy compliance associated with those three platforms and three integrations. If the provider on-boards yet another platform, a total of six integrations may be required (e.g., 4 choose 2). If the provider on-boards a fifth platform, a total of ten integrations may be required (e.g., 5 choose 2). Generally, difficulties of maintaining integrations between different software platforms (in a permissions policy compliant manner) scales exponentially with the number of platforms provided.

Further to the inadvertent disclosure risk and maintenance obligations associated with inter-platform integrations, each integration is still only configured for information sharing, and not automation of tasks. Although context switching to copy data between two integrated platforms may be reduced, the quantity of tasks required by individual users may not be substantially reduced.

Further solutions involve creating and deploying dedicated automation platforms that may be configured to operate with one, and/or perform automations of, or more platforms of a multiplatform system. These, however, much like automation engines in-built to individual platforms, may be difficult to use, access, or understand. Similarly, much like integrations described above, dedicated automation platforms require separate maintenance and employee training, in addition to licensing costs and physical or virtual infrastructure allocations to support the automation platform(s).

In still further other circumstances, many automations may take longer for a user to create than the time saved by automating that particular task. In these examples, individual users may avoid defining automations altogether, despite that, in aggregate, automation of a given task may save an organization substantial time and cost.

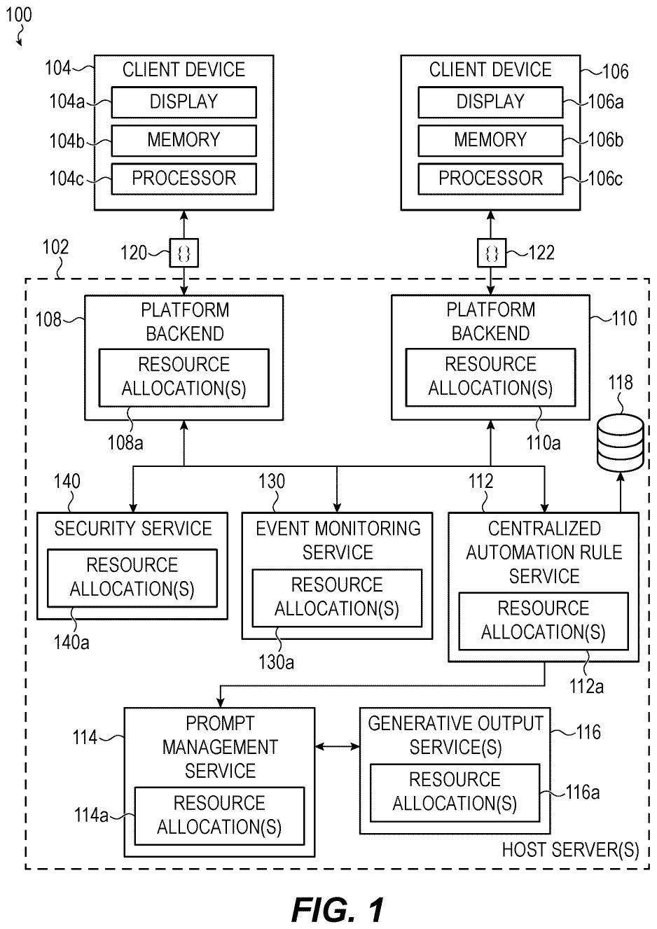

These foregoing and other embodiments are discussed below with reference to FIGS. 1-18. However, the detailed description given herein with respect to these figures is for explanation only and should not be construed as limiting.

FIG. 1 depicts a simplified diagram of a system 100 that includes a centralized automation rule service for the creation and management of automation rules, as described herein. The system 100 is depicted as implemented in a client-server architecture, but it may be appreciated that this is merely one example and that other communications architectures are possible.

In particular, the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices. Two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform, an issue tracking platform, a source code management platform, and/or a manufacturing resource planning platform. Other examples are information technology system management (ITSM) systems, chat platforms, messaging platforms, and the like. These backends can be communicably coupled to a centralized automation rule service 112 that can be leveraged to provide functionality to each respective backend. For example, the centralized automation rule service 112 can be configured to receive user prompts, such as described herein, to modify, create, or otherwise perform operations to build, validate, debug, or otherwise create and manage automation rules acting on content stored by each respective software platform and triggered by events that may occur at one or more of the software platforms. The centralized automation rule service 112 may provide a single, unified interface to automation rules that operate across different platforms of the host servers 102, providing management and creation capabilities across different platforms of the system.

By centralizing the automation rule service in this manner, the centralized automation rule service 112 can also serve as an integration between multiple platforms. For example, one platform may be a documentation platform and the other platform may be an issue tracking system. In these examples, a user of the documentation platform may create an automation rule that is triggered off of an event that occurs at the documentation platform. An action in response to this event may be performed on one or more objects of the issue tracking system. In some examples, the event may be obtained at or provided to an event monitoring service 130. The event may then be provided to or fetched by the centralized automation rule service 112 as an event message, for example a user identity event message that may fulfil or otherwise satisfy a trigger criteria for one or more automation rules managed or created at the centralized automation rule service 112.

A portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each be communicably coupled with a centralized automation rule service 112 (also referred to as an “automation rule builder” or an “automation rule manager”).

The centralized automation rule service 112 can be configured to cause rendering of a GUI within respective frontends of each of the first platform backend 108 and the second platform backend 110. In this manner, and as a result of this construction, each of the first platform and the second platform present a consistent automation rule creation and management experience for a user.

The centralized automation rule service 112 may include both text input functions as well as selectable graphical elements to select and edit automation rules and components. Selected graphical elements may represent triggers and/or action across different platforms. As a result of the text input or selection of graphical elements, the centralized automation rule service 112 may present graphical elements representing the selected components that make up an automation, for example on the display 104a of a client device 104, or on the display 106a of the client device 106. As a result of this centralized architecture, multiple platforms in a multiplatform environment can leverage the features of the automation rule service. This provides a consistent experience to users while providing cross-platform features for the automation rules.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized automation rule service 112 that can be called by each respective frontend whenever it is required to present the user of that respective frontend with an interface to create and manage automation rules.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized automation rule service 112 can be extended to include additional features and functionality that, in turn, can automatically be leveraged by any further platform that incorporates an automation rule builder, and/or otherwise integrates with the centralized automation rule service 112 itself.

In some examples, prompts can be provided as input to a prompt engineering/prompt preconditioning service (such as the prompt management service 114) that, in turn, provides a modified user prompt as input to a generative output service 116. The generative output service 116 may be hosted over the host servers 102 or, in other cases, may be a software instance instantiated over separate hardware. In some cases, the generative output service 116 may be a third-party service that serves an API interface to which one or more of the host services and/or preconditioning service can communicably couple.

The generative output engine can be configured as described above to provide any suitable output, in any suitable form or format. Examples include content to be added to user-generated content, API request bodies, replacing user-generated content, and so on. In some cases, the generative output service 116 can be configured to provide an output as part of an action of an automation rule. The output can be in response to a prompt that includes content referenced by the automation rule, for example a summary of the content created when the automation rule is triggered and run.

More generally, in some embodiments described herein, a centralized automation rule service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized automation rule service 112 as described herein can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More specifically, the first platform backend 108 can be configured to communicably couple to a first platform frontend instantiated by cooperation of a memory and a processor of the client device 104. Once instantiated, the first platform frontend can be configured to leverage a display of the client device 104 to render a GUI so as to present information to a user of the client device 104 and so as to collect information from a user of the client device 104. Collectively, the processor 104c, memory 104b, and display 104a of the client device 104 are identified as the resources of the client devices, respectively.

As with many embodiments described herein, the first platform frontend can be configured to communicate with the first platform backend 108 and/or the centralized automation rule service 112. Information can be transacted by and between the frontend, the first platform backend 108 and the centralized automation rule service 112 in any suitable manner, form, or format. In many embodiments, as noted above, the client device 104 and in particular the first platform frontend can be configured to send an authentication token 120 along with each request transmitted to any of the first platform backend 108, the centralized automation rule service 112, the preconditioning service, or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a GUI so as to present information to a user of the client device 106 and to collect information from a user of the client device 106. Collectively, the processor 106c, memory 106b, and display 106a of the client device 106 are identified as the client device resources, respectively.

As with many embodiments described herein, the second platform frontend can be configured to communicate with the second platform backend 110 and/or the centralized automation rule service 112. Information can be transacted by and between the frontend, the second platform backend 110 and the centralized automation rule service 112 in any suitable manner, form, or format. In many embodiments, as noted above, the client device 106 and in particular the second platform frontend can be configured to send an authentication token 122 along with each request transmitted to any of the second platform backend 110 or the centralized automation rule service 112.

As a result of these constructions, the centralized automation rule service 112 can provide uniform feature sets to users of either the client device 104 or the client device 106. For example, the centralized automation rule service 112 can implement an automation rule processor to receive an automation rule input provided by a user of the client device 104 to the first platform and/or to receive an automation rule input provided by a different user of the client device 106 to the second platform. Created automation rules may then be accessible to each user via the different ones of client device 104 and client device 106 for management, editing, and so on.

As noted above, the centralized automation rule service 112 ensures that common features are available to frontends of different platforms. One such class of features provided by the centralized automation rule service 112 invokes output of a generative output engine of a service such as the generative output service 116. For example, as noted above, the generative output service 116 can be used to generate content, supplement content, and/or generate API requests or API request bodies that cause one or both of the first platform backend 108 and the second platform backend 110 to perform a task. In some cases, an API request generated at least in part by the generative output service 116 can be directed to another system (not depicted with reference to system 100). For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

The prompt management service 114 can be configured to receive user input (provided via a GUI of the client device 104 or the client device 106) from the centralized automation rule service 112. The prompt management service 114 can also be configured to receive an automation rule input from the centralized automation rule service 112 in connection with running of an automation rule. The user input or automation rule input may include a prompt to be continued by the generative output service 116. The prompt management service 114 can be configured to modify the user input or automation rule input, supplement the input, select a prompt from a database (e.g., the database 118) based on the input, insert the input into a template prompt, replace words within the input, perform searches of databases (such as user graphs, team graphs, and so on) of either the first platform backend 108 or the second platform backend 110, change grammar or spelling of the input, change a language of the input, and so on. The prompt management service 114 may also be referred to herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input. More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible).

In response to receiving a modified prompt as input, the generative output service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative output service 116 can be provided to the centralized automation rule service 112 to return to a suitable backend application, to in turn return to or perform a task for the benefit of a client device such as the client device 104 or the client device 106. More particularly, it may be appreciated that although system 100 is illustrated with only the prompt management service 114 communicably coupled to the generative output service 116, this is merely one example and that in other cases the generative output service 116 can be communicably coupled to any of the client device 106, the client device 104, the first platform backend 108, the second platform backend 110, the centralized automation rule service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, some embodiments described herein, and with particular reference to system 100, relate to systems for running automation rules. Those automation rules may collect one or more portions of content of the system 100, modify that user input into a particular engineered prompt, and submit that prompt as input to a trained large language model. Output of the LLM can be used in a number of suitable ways.

These foregoing embodiments depicted with reference to system 100 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a. Similarly, the second platform backend 110 may be instantiated over the resource allocations 110a (including processors, memory, storage, network communications systems, and so on).

The event monitoring service 130 can be supported by its own resources including processors, memory, network connections, displays (optionally), and the like represented in the figure as the resource allocations 130a. Also, the security service 140 can be supported by its own resources including processors, memory, network connections, displays (optionally), and the like represented in the figure as the resource allocations 140a.

Likewise, the centralized automation rule service 112 is supported by a processor and memory and network connection (and/or database connections) collectively represented for simplicity as the resource allocations 112a. The prompt management service 114 can be supported by its own resources including processors, memory, network connections, displays (optionally), and the like represented in the figure as the resource allocations 114a. In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organization's datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to KanbanBoard456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to KanbanBoard456, and whether the requesting user has read access to the referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect key words or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized automation rule service.

As further described herein, the system 100 supports automation rule creation. In one or more embodiments, a GUI is displayed at a client device that includes an input field. In some cases, the client device 104, associated with the first platform backend 108, provides an interface with a first type of software platform, and the client device 106, associated with the second platform backend 110, provides an interface with a different type of software platform. Either or both of client device 104 and client device 106 may generate a GUI allowing user input for automation rule generation. As further described herein, the host servers 102 can utilize the services of a generative output service 116 to programmatically generate automation rules or portion of automation rules from inputs, including one or more natural language inputs or selections of graphical elements. In some examples, the generative output service 116 can be used to provide indications (e.g., suggestions, recommendations) for automation rule components for selection by a user as part of automation rule building and creation.

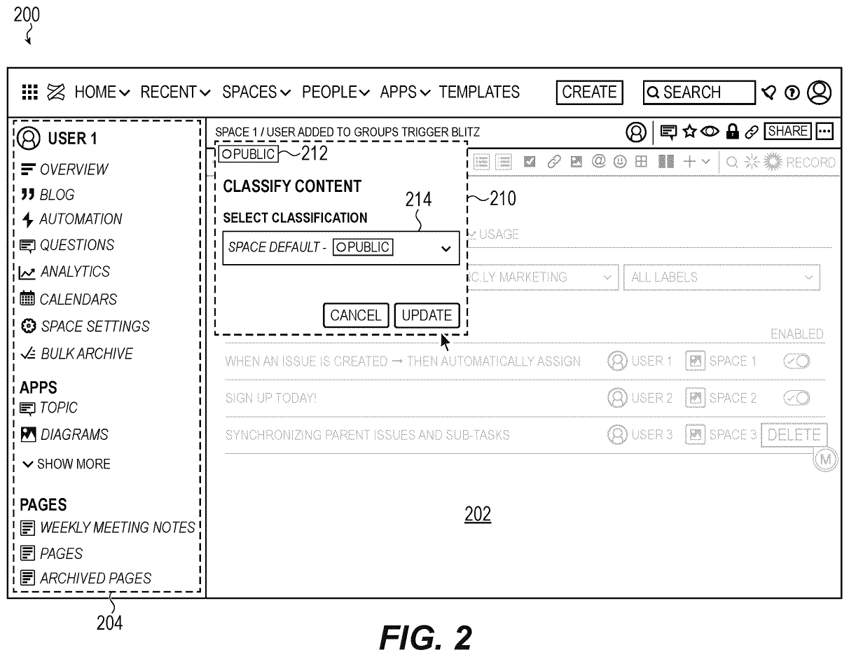

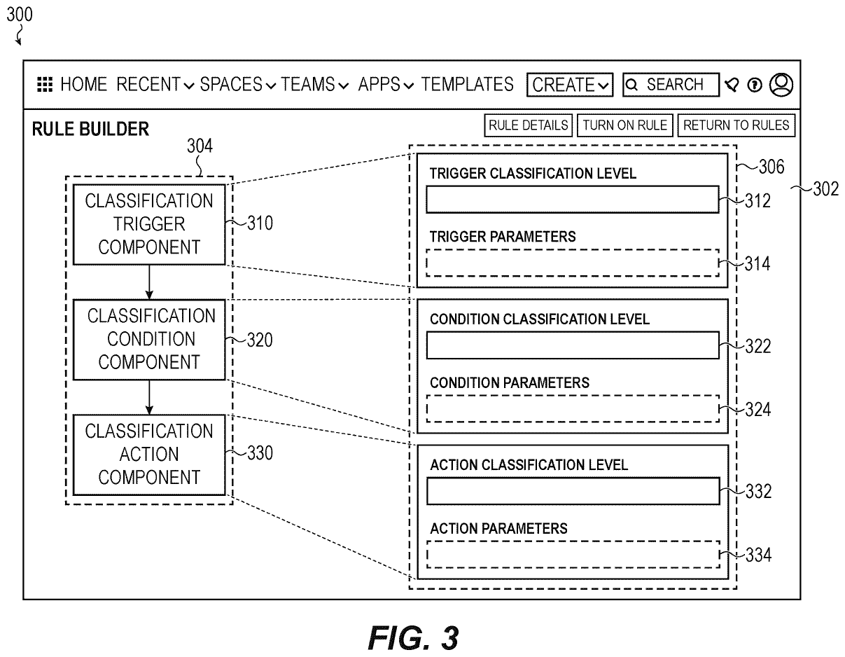

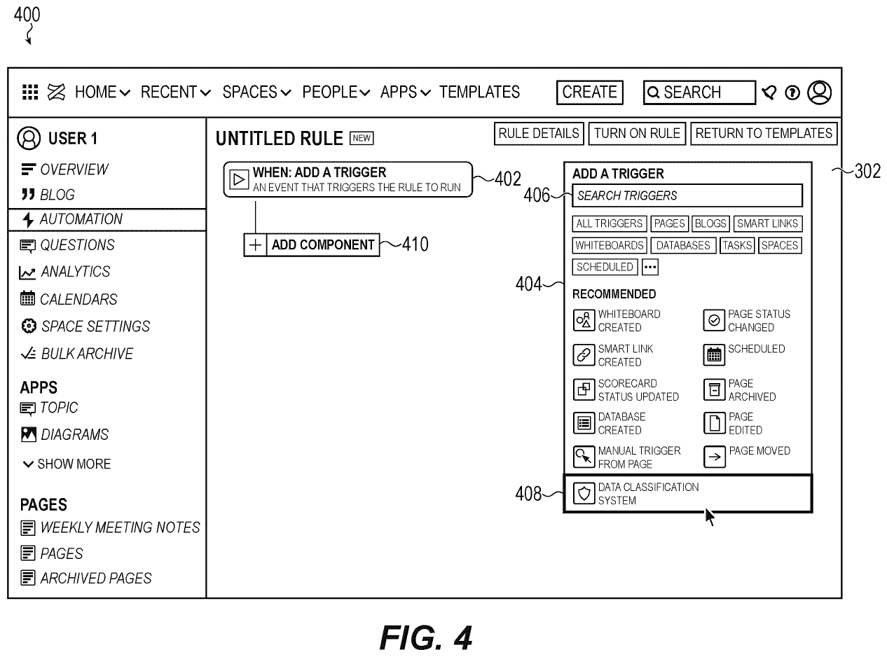

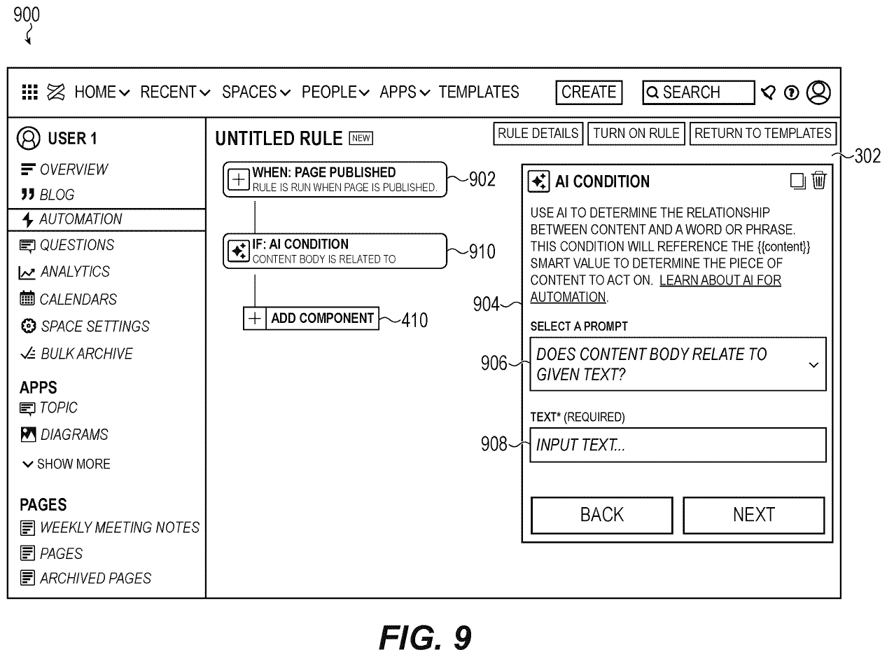

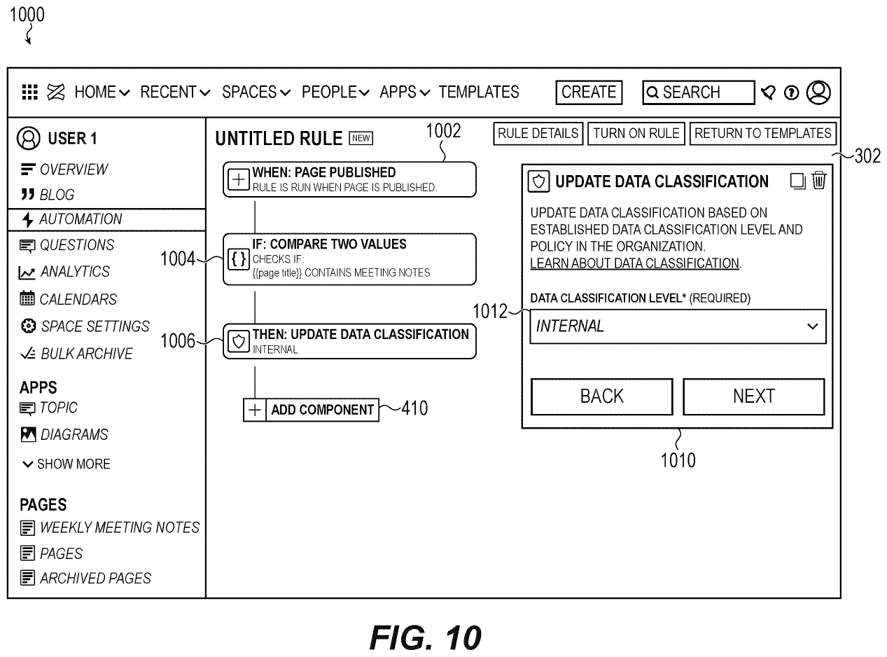

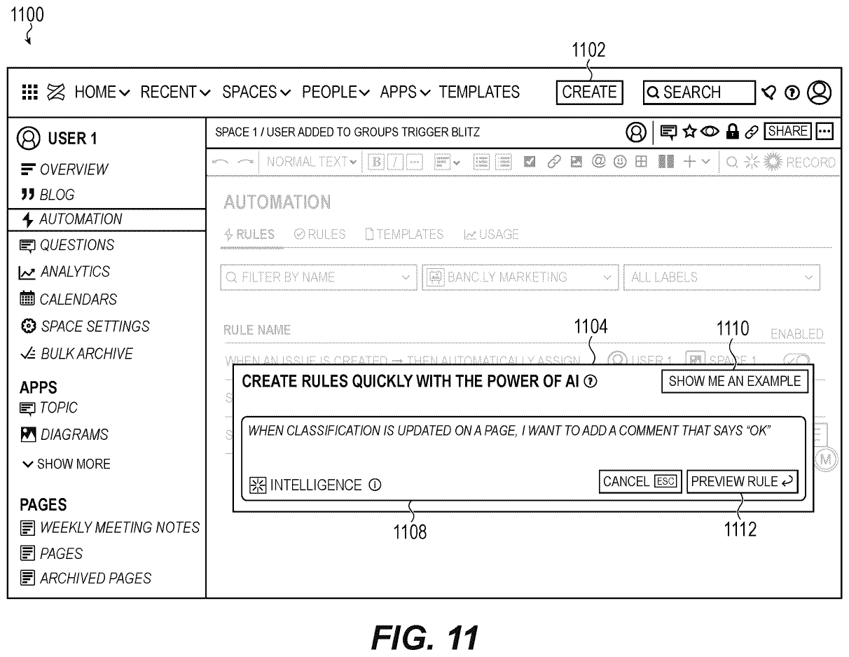

FIG. 2 generally depicts a frontend interface in an example to classify or reclassify content, which may trigger an automation rule. FIG. 3 generally depicts aspects of a frontend interface utilizing a classification trigger component, a classification condition component, and/or a classification action component. FIGS. 4-8 generally depict frontend interfaces in an example of automation rules that utilize a classification trigger component. FIG. 9 generally depicts aspects of a frontend interface in an example of automation rules utilizing a generative output engine for a condition component. FIG. 10 generally depicts aspects of a frontend interface in an example of automation rules utilizing a classification action component. FIG. 11 generally depicts aspects of a frontend interface in an example of utilizing a generative output engine to generate automation rules using one or more of a classification trigger component, a classification condition component, and/or a classification action component.

FIG. 2 depicts an example frontend interface 200, that supports one or more aspects of automated data classification for collaboration platforms, as further described herein. Frontend interface 200 may also be referred to as a UI or GUI. In one or more embodiments, frontend interface 200 may be at least a part of a GUI that is rendered by one of first platform backend 108 or second platform backend 110 and displayed at client device 104 or client device 106, respectively. In one or more embodiments, the block diagram of the example frontend interface 200 supports one or more aspects of user-defined button elements for collaboration platforms, as further described herein.

The frontend interface 200 depicts a graphical user interface in an editor or editing view mode. For example, a graphical user interface of frontend interface 200 is a rendering of an electronic document, page, or other electronic content on a client device, such as the client device 104 or 106. The editor is displaying user-generated content of an electronic document hosted by a collaboration platform. The electronic document, page, or other electronic content may be rendered on the client device upon authorization/authentication of a user by an authentication/authorization service, and based on permissions granted to the user according to a user profile associated with the user. In one example, a graphical user interface associated with the frontend interface 200 may have various partitions/sections displaying different content. For example, the frontend interface 200 may include a navigational panel 204, and a content panel 202 that may contain user-generated content of an electronic document.

The navigational panel 204 may include a hierarchical element tree, which may also be referred to herein as a page tree. An exemplary page tree is labeled as “pages” in the navigational panel 204. The hierarchical element tree may include an array of hierarchically arranged tree elements. Each tree element of the array of hierarchically arranged tree elements may be positioned and/or displayed with respect to its respective relationship with a current electronic document, page, or electronic content being displayed in the content panel 202. Further each tree element of the array of hierarchically arranged tree elements may be selectable. In other words, in response to a user action or user input with respect to a tree element, an electronic document, page, or electronic content associated with the tree element may be displayed in the content panel 202, or a new instance of a graphical user interface.

Within the navigational panel 204, for example, the selection of a tree element for a page, including weekly meeting notes, pages, or archived pages may display the corresponding user-generated content in the content panel 202. According to the example illustrated for the frontend interface 200, content is displayed as the user generated content within the content panel 202. Although not shown, indicators of information associated with the content in the content panel 202 may be displayed within proximity of the content, for example an owner of the content, a tag, and a classification (e.g., content classification).

In some examples, a user for the frontend interface 200 may add a classification or revise, update, or otherwise modify classification for the content. In some examples, a user may click on, hover over, or otherwise select an indicator of the classification and, in response, a classification editing window 210 may be rendered and displayed at the frontend interface 200. A current classification indicator 212 (e.g., an indicator of an “old” classification level) may be displayed in the classification editing window 210. A classification input field 214 may also be displayed in the classification editing window 210 and configured to receive a user input of a revised, updated, or other modified classification for the content (e.g., an indicator of a “new” classification level).

In some examples, the classification may be selected via a drop-down menu that provides a list or set of classifications (which may be also referred to as classification levels or candidate classifications) from which the classification may be selected. The classification name may also be provided by a user by entering a text string in the classification input field 214, where such label may be new (e.g., not already in the collaboration platform) or existing. In yet other examples, a user may enter a text string in the first input 332, and the collaboration platform may provide one or more suggested groups based on the entered text string. In some examples, the classification input field 214 may provide a search function to a database of classifications associated with a particular collaboration platform or the system 100. In some examples, the classifications available as candidates may be specific to a particular type of content, space or other grouping or content. In other examples, the candidate classifications that are available may be specific to a user, type of user, or user group. For example, a first user may have the ability to classify content according to a first set of classification levels (e.g., only internal and more restrictive classifications, but not public classification), whereas a second user may have the ability to classify content according to a second set of classification levels (e.g., all classification levels, including public classification).

A classification level may be associated with a particular set of settings, including default settings. A permissions set (e.g., including one or more of a view, an edit, or a create permission) may change depending on the classification level. For example, a restricted classification level have a default “deny all” permission set with a list of white labeled or permitted users and/or groups or teams that may access the content item(s) associated with the restricted classification level. As another example, a confidential classification level may limit access to users and/or groups or teams identified by user, group, or team. In some examples, content items with a confidential classification level may not be shared externally, for example export or print function may be disabled without an override by an authorized user. In another example, a public classification level may be associated with a classification level where editing functions are allowed for certain groups or users (e.g., the owner or creator of the content item), but functions such as view, read, print, and export may be unrestricted.

As further described herein, a change in the classification level for content may act as an event triggering one or more automation rules, including automation rules that include a classification trigger component. The example frontend interface 200 may provide one mechanism to change the classification level for content. Any other suitable manual or automated classification or re-classification of content that generates an event satisfying a criteria of the classification trigger component may be used consistent with the techniques described herein.

In some examples, a change in the classification level for one content item may cause a change in the classification of some or all of the dependent or child content items associated with that content item. For example, if a parent page includes a set of child pages, and the classification level of the parent page is changed to a restricted classification level, then the set of child pages may also be reclassified to the restricted classification level. As such, a change in classification level may be propagated throughout a hierarchy of classification levels for content items where such hierarchies (e.g., trees, or other structures) exist.

In some examples, a change in a classification level may propagate in one direction, but not another, for a set of classification levels (e.g., according to a default setting, or a parameter set for an automation rule). For example, a change to a more restrictive classification level may be propagated through a hierarchy, but a change to a less restrictive classification level may not be propagated. In some examples, a change to a classification level may be directionally specific, such that a classification level change to a more restrictive classification level (a new classification level) from a less restrictive classification level may trigger an automation rule, but a change to the new classification level from a more restrictive classification level may not trigger the same automation rule. In other examples, a change in classification level in one direction (e.g., more restrictive) may trigger a first set of actions (or no action), while a change in classification level in another direction (e.g., less restrictive) may trigger a second set of actions. For example, a change in classification level to more restrictive may trigger the sending of a notification (e.g., email, alert, and so on) to an owner of a document or a group, while a change in the classification level to a less restrictive classification level may result in publication to a log, but not notification to the owner.

FIG. 3 depicts an example frontend interface 300 that supports one or more aspects of automated data classification for collaboration platforms, as further described herein. Frontend interface 300 may also be referred to as a UI or GUI. In one or more examples, frontend interface 300 may be rendered and displayed in response to a user selecting a rule builder button. As used herein, a “button” generally refers to a selectable graphical element (e.g., user-selectable graphical element). In some examples, the frontend interface 300 may be displayed responsive to a user input navigating through the “automation” button (e.g., a selectable graphical element), for example as shown in the navigational panel 204. The frontend interface 300 displays the rule builder 302, which includes graphical elements to assist a user in generating an automation rule to operate in a collaboration system (e.g., system 100), as further described herein. In some embodiments, rule builder 302 may be at least a part of a GUI that is rendered by one of first platform backend 108 or second platform backend 110 and displayed at client device 104 or client device 106, respectively. The rule builder 302

In one or more examples, rule builder 302 may include a proposed automation flow (or workflow) region 304 and a control region 306. Generally, the proposed automation flow region 304 includes graphical elements representing automation rule components. In some examples, the graphical elements representing automation rule components may be replaced during rule building with graphical elements representing selected automation rule components.

The proposed automation flow region 304 may include a trigger adding button that may be replaced by a graphical element representing a classification trigger component 310 that is selected. The trigger adding button may also generally be a component adding button. The classification trigger component 310 may be used to designate (e.g., in a classification trigger modification window) a trigger classification level via an input 312 with respect to a detected event, as well as zero or more trigger parameters 314 associated with the trigger classification level.

In some examples, the classification trigger component 310 may be a “classification updated” trigger component. For example, the corresponding automation rule may run (e.g., execute, process, and so on) when the classification level is updated to a level that corresponds to the indicated trigger classification level. For example, if the classification level indicated by the input 312 is set to “restricted,” then the automation rule may be triggered. In other examples, the corresponding automation rule may run when the classification level is updated away from a level that corresponds to the indicated trigger classification level via input 312. For example, if the classification level indicated by the trigger classification level is “confidential,” and the classification level is changed from “confidential” to “public” (or any classification other than “confidential”) then the automation rule may be triggered.

In one or more examples, a trigger parameter may be indicated via input 314. A trigger parameter may provide a scope for applicability of the trigger. For example, the trigger parameter for a classification trigger component 310 may indicate that the trigger applies when the classification level is changed to the indicated classification level. In other examples, the trigger parameter may indicate that the trigger applies when the classification level is changed away from the indicated classification level. In yet other examples the trigger parameter may indicate that the trigger applies for a classification level change to a classification level at or above some classification level (e.g., on a defined scale or restrictiveness or other metric for the classification), or at or below some classification level (e.g., on a defined scale or restrictiveness or other metric for the classification).

The proposed automation flow region 304 may include a condition adding button that may be replaced by a graphical element representing a classification condition component 320 that is selected. The condition adding button may also generally be a component adding button. The classification condition component 320 may be used to designate (e.g., in a classification condition modification window) a condition classification level via input 322 for an automation rule, as well as zero or more condition parameters (via input 324) associated with the condition classification level.

In some examples, the classification condition component 320 may act as a filter, providing specific circumstances under which the automation rule should be triggered. In other words, the automation rule may be triggered according to a trigger component (e.g., the classification trigger component 310, or another trigger component), where the automation rule proceeds if the condition is met, and does not proceed if the condition is not met. In some examples, the classification condition component 320 may be associated with a particular condition classification level with respect to a detected event, as well as zero or more condition parameters associated with the condition classification level.

In an example of a classification condition, the classification condition component 320 may be classification level comparison. For example, the condition classification level indicated via input 322 may be a classification level in a classification hierarchy for a set of classification levels. The condition parameter indicated via 324 may be selected from a set of terms of comparison, such as “more restrictive than,” “at least as restrictive as,” “less restrictive than,” or “no more restrictive than.” In an example, the condition

For the classification condition component 320, the condition may determine whether content (e.g., a page, issue, task, board, or other electronic document) relates to a classification change or update. In some examples, a generative output service may be utilized to determine whether the classification is met, for example as further described with reference to the frontend interface 900 below.

The proposed automation flow region 304 may include an action adding button that may be replaced by a graphical element representing a classification action component 330 that is selected. The action adding button may also generally be a component adding button. The classification action component 330 may be used to designate (e.g., in a classification action modification window) an action classification level via input 332 for an automation rule, as well as zero or more action parameters via input 334 associated with the action classification level.

In some examples, the classification action component 330 may be an “update classification” action component (e.g., or “modify classification,” and so on). That is, the action classification level may be identified via input 332 as the level to which the classification level is to be set for the automation rule. For example, the classification level indicated via input 332 may be “confidential,” in which case the classification action component 330 may set the classification level may be set to “confidential” for the content (e.g., page, space, issue, etc.) that triggered the automation rule. The action parameters may set one or more parameters for the classification level set via input 334. For example, the action parameters may be set so that the classification action component 330 applies to both a created issue or task, but also each issue or task that is related to or a child of the issue or task.

Although classification components are illustrated, including the classification trigger component 310, the classification condition component 320, and the classification action component 330, as further described herein, one or more of the classification components may be omitted and/or replaced with an automation rule component that is not a classification component. Any suitable combination of classification components may be used in combination with one or more non-classification components. For example, a complete automation rule may include the classification trigger component 310 and one or more action components (that do not include a classification action component 330), and the classification condition component 320 omitted. In another example, a complete automation rule may include a trigger component (that does not include a trigger classification component 310) and a classification action component 330, and the classification condition component 320 omitted. In another example, a trigger classification component 310 and a classification condition component 320 may be used together with one or more (non-classification based) action components. In yet another example, a (non-classification based) trigger component may be used together with a classification condition component 320.

Additionally, one or more classification components may be used in an automation rule and one or more additional components, including various combinations of conditions, actions, branches, and so on, may be used in connection with automation rules that use classification components for automation rules, as further described here.

As used herein, an input or input field (e.g., one or more of the input 312, the input 314, the input 322, the input 324, the input 332, and/or the input 334) may generally be populated via a text entry, or be populated via a drop-down selection. In some cases, text may be suggested (e.g., auto-populated) as a user types. The suggestion may be context-specific. For example, the suggested text for an issue tracking platform may be different from a document management platform. Similarly, the suggested text may be component-type specific, for example different for the classification trigger component 310, the classification condition component 320, and/or the classification action components 330.

Although described with reference to a classification level, there may be multiple trigger classification levels for the classification trigger component 310, and the classification trigger component 310 may include multiple input fields for the multiple trigger classification levels. Similarly, there may be multiple condition classification levels for the classification condition component 320, and the classification component 310 may include multiple input fields for the multiple trigger classification levels.

In some examples, the event that triggered the classification trigger component 310 may be of a first platform (e.g., the first platform backend 108), and an object referenced by an action component of the automation rule may be of a second platform (e.g., the second platform backend 110). For example, a classification may be modified on a first platform, while the action resulting from the classification may be performed on a second platform. For example, a classification level of a page or a space may be changed in a document management platform, and an issue created in an issue tracking platform or an email sent via a communication platform in response.

In some examples, the event that triggered a trigger component 310 may be of a first platform (e.g., the first platform backend 108), and an object referenced by the classification action component 330 of the automation rule may be of a second platform (e.g., the second platform backend 110). For example, an event may be generated from a first platform, causing an event to be reported that satisfies a trigger condition of the automation rule. The action resulting from the event may then be performed on a second platform. For example, a page having a certain owner may be published, triggering the automation rule, and as a result an issue may be generated in an issue tracking system and the classification level of the issue set to a particular classification level.

In yet another example, a criteria for a trigger may be satisfied in a first collaboration platform, and an action of a classification action component 330 performed in the first collaboration platform, but a classification condition component 320 checked in a second collaboration platform. For example, in response to an issue created for an owner or group in an issue tracking platform, the classification condition component 320 may use a generative output engine to evaluate content by a same owner or group in a document management platform to determine which classification level to apply, or whether to apply a particular classification level. If, according to the generative output engine, a particular classification level is associated with content of the same owner or group in the document management platform, the automation rule may then apply the classification level to the issue created for the owner or group in the issue tracking platform.

In some embodiments, user permissions may be evaluated when the automation rule is run, including when the automation rule operates across platforms, or between one of the platforms and a non-platform system. That is, as part of running an automation rule that starts, is initiated, or otherwise triggered in a first platform, a trigger (including a classification trigger or classification trigger component), a condition (including a classification condition or classification condition component), or actions (including a classification action or classification action component) may use a second platform as described herein. In such cases, the process of performing the automation rule may further include verifying or checking the credentials (e.g., permissions and/or restrictions) of a user with the second platform. In some examples, access may be granted or denied based on a user role. Where an automation rule has been created (e.g., established as a service), if the user does not have sufficient permissions to access an object of the second platform, then the automation rule may cease to run or fail. In one or more examples, an error message or other indicator may be provided to the user or logged to indicate the failure to run the automation rule by reason of a lack of permissions. In some examples, where one or more components of the automation rule require checking permissions to access an object of a platform (e.g., the second platform or a non-platform system referenced by the automation rule), a GUI may be displayed to a user for the user to enter the user's credentials associated with that platform. The entered credentials may then be provided to the platform to allow the automation rule to continue to run.

A content classification change may be made responsive to an event. In some examples, the user that triggered the event, or the owner of the content corresponding to the content, may be provided and receive a message including an indication of the content classification change, or a summary of classification changes pertinent to the event.

In some examples, a user may be associated with (e.g., the owner or creator) of content of a collaboration platform. This content (e.g., of second collaboration platform) may be associated with a particular classification level. According to one example, a classification action indication by a classification action component 330 may re-classify content associated with the user to a second classification level based on the user being added to a group as the event that triggers the automation rule (e.g., the trigger component being a user added to a group). For example, where the group is associated with a more restrictive level, then the content created or owned by the user may also be re-classified, for example to the more restrictive level.

FIG. 4 depicts an example frontend interface 400 that supports one or more aspects of automated data classification for collaboration platforms, as further described herein. Frontend interface 400 may also be referred to as a UI or GUI. In one or more embodiments, frontend interface 400 may be displayed at a same display or interface as one or more of the frontend interfaces described herein. The frontend interface 400 displays the rule builder 302, which includes graphical elements to assist a user in generating an automation rule to operate in a collaboration system (e.g., system 100), as further described herein. In some embodiments, rule builder 302 may be at least a part of a GUI that is rendered by one of first platform backend 108 or second platform backend 110.

Generally, the proposed automation flow region includes graphical elements representing automation rule components. In some examples, the graphical elements representing automation rule components may be replaced during rule building with graphical elements representing selected automation rule components. For example, the proposed automation flow region may include a trigger adding button 402 that may be replaced by a graphical element representing a selected trigger component, and a component adding button 410 that may be replaced by a selected action component. The proposed automation flow region may expand or contract as automation rule components (and their respective graphical elements) are added or deleted.

Generally, the control region may include a search box for automation rule components, tabs for categories of those automation rule components, and graphical elements representing selectable automation rule components.

In one or more embodiments, the rule builder 302 of the frontend interface 400 may include a search box 406, a set of tabs, and a set of trigger components in the control region, and a trigger adding button 402 and a component adding button 410 in the automation workflow region. Frontend interface 400 illustrates a simplified view. In some embodiments, rule builder 302 may be embedded within another GUI (e.g., window), or include one or more additional textual and/or graphical elements not shown with reference to frontend interface 400.

The search box 406, the set of tabs, and the set of trigger components may be rendered and displayed to a user, for example responsive to the user initiating (starting, entering) the rule builder 302 and selecting the graphical element that is the trigger adding button 410. In some embodiments, after selecting a trigger component for an automation rule, a user may select the graphical element that is the add a component, button 410. In other embodiments, a user may select the graphical element that is the add button 410 before selecting the trigger component.

The set of trigger components 410 includes trigger components that may be used to initiate an automation rule based on an event. In some embodiments, the triggers may be organized into one or more groups or subsets of triggers components. In the example of the frontend interface 400, the group of recommended trigger components are shown. However, other groups may include pages and blogs, tasks, spaces, scheduled, and/or integrations. In this example, the recommended triggers include a classification trigger component (e.g., data classification system 408). a whiteboard created, page status changes, a smart link created, a scheduled event, a scorecard status updated, a page archived, a database create, a page edited, a manual trigger from page, and a page moved. In other examples, the recommended triggers may include a manual trigger from a page, a page moved, a page published, or a page status changed, for example page published trigger. Pages and blogs triggers may include a manual trigger from a page, at attachment added to a blogpost, an attachment added to a page, at attachment deleted from a blogpost, an attachment deleted from a page, a blog commented, a blog labeled, a blog published, a page archived, a page comments, a page copied, a page deleted, a page edited, a page labeled, a page moved, a page owner changed, a page published, a page status changed, or a user mentioned. Task triggers may include task created and task status changed. Spaces triggers may include space archived, space created, or space deleted. Other triggers of the set of triggers may include a scheduled trigger or an incoming webhook trigger.

In some embodiments, trigger components may include one or more of a field value changed, form submitted, incoming webhook, issue assigned, issue commented, issue comment edited, issue created, issue deleted, issue linked, issue link deleted, issue moved, issue transitioned, issue updated, a manual trigger from an issue, a combination of issues, when work is logged, a sprint is created, started, or completed, a version is created, updated, or released, a branch created, build failed, build status changed, build successful, commit created, deployment failed, deployment status changed, deployment successful, pull request create, pull request, declined, pull request merged, vulnerability found, object triggered, service limit breach, a service legal agreement threshold breached, approval required, approval completed, or an emoji reaction to application message. In some embodiments, these example triggers are intended for use with reference to the context of an issue tracking platform.

Additionally, or alternatively, trigger components may include one or more of a page archived, page commented, page copied, page deleted, page edited, page labeled, page moved, page owner changed, page published, page status changed, attachment added to page, attachment deleted from page, attachment deleted from page, manual trigger from page, task created, task status changed, blog commented, blog labeled, blog published, attachment added to blog, attachment deleted from blog, user mentioned, space archived, space created, or a combination of these. In some embodiments, these example triggers are intended for use with reference to the context of a documentation platform.

In one or more embodiments, the recommended triggers of the set of trigger components 404 may be based on a usage history for the user, such as the quantity of uses for the trigger component exceeding a threshold value or the user's most used trigger components (e.g., ten most used trigger components). In other embodiments, the recommended triggers are based on the quantity of uses by a group of users (e.g., of the platform, or accessing a centralized automation rule service 112), and may include the most used trigger components or the trigger components whose usage has exceeded a threshold value. In some cases, the recommended triggers may be a curated list within a platform or the centralized automation rule service 112, and may depend on which platform a user is accessing. In some embodiments, a generative output service may be trained on the usage of trigger components for automation rules within a platform or set of platforms, and be used to determine the recommended trigger components based on one or more inputs and a list of potential or candidate trigger components. In some examples, the generative output service can receive (e.g., from the centralized automation rule service 112) information regarding a history of trigger component selections (e.g., for a particular user, group of users, particular platform, or by other groupings), and this information used by the generative output service to provide (e.g., from the centralized automation rule service 112) an indication (e.g., suggestion or recommendation) for a trigger component or set of trigger components 404 (e.g., as the “recommended” trigger components) as part of automation rule building and creation.

Search box 406 accepts textual inputs from a user, and in response, the rule builder 302 can filter the set of trigger components 404. In some embodiments, the displayed set of trigger components 404 may be pared down such that only trigger components that satisfy the search are displayed (and other, non-responsive trigger components hidden). In other embodiments, a drop-down or pop-up may be displayed that includes selectable trigger components that satisfy the search.

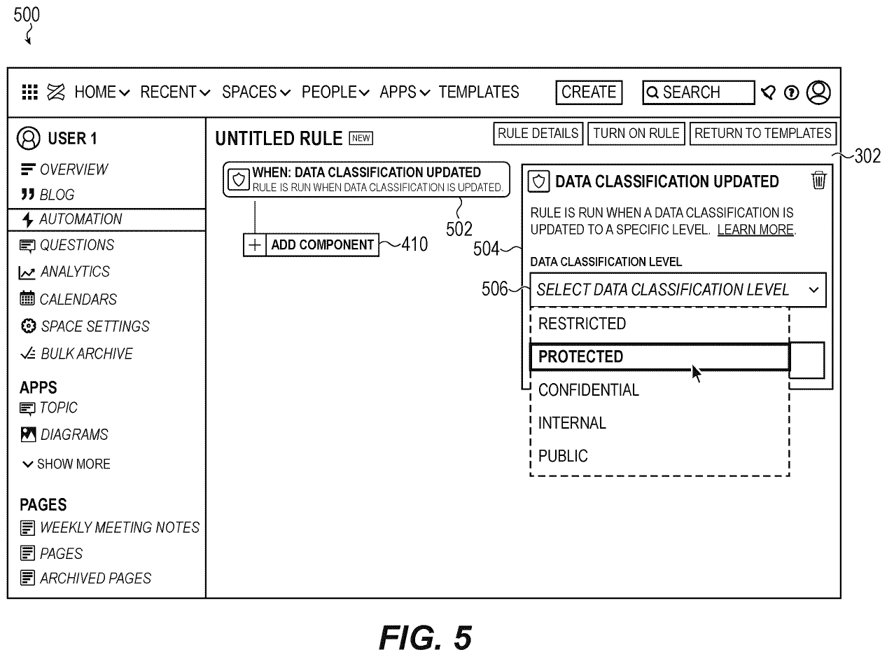

FIG. 5 depicts an example frontend interface 500 that supports one or more aspects of automated data classification for collaboration platforms, as further described herein. Frontend interface 500 may be an example of frontend interface 400 following selection by a user of a data classification updated trigger component that is triggered by the classification (e.g., data classification) of an item of content (e.g., electronic document, page, task, issue, and so on, as further described herein) being updated. For example, the classification may be changed from “restricted” to “confidential,” or “public” to “internal.” Following selection of the data classification updated trigger component, a graphical element 502 representing the data classification updated trigger component may be shown as part of the automation rule flow. In some examples, the graphical element 502 representing the data classification may be an example of a classification trigger component 310.

A classification trigger modification window 504 may be displayed, for example when a user selects to include a classification trigger component, and in particular a data classification updated trigger component (e.g., data classification system 408), in the automation rule. The data classification updated trigger component may be an example of a classification trigger component 310 further described herein. Also, classification trigger modification window 504 may be displayed upon selection of the data classification updated trigger component during modification or editing of the automation rule flow.

The component specification window 504 includes an input field 506 for the input of a classification level (e.g., data classification level). The classification level may be directly entered or typed into the field, selected from a list of candidate classification levels (e.g., as a drop-down list), or candidate classification levels suggested to the user as a user inputs a portion (e.g., a first one or more letters) of the classification level. Examples of a set of data classification levels include a restricted, a protected, a confidential, an internal, or a public classification level. Other sets of classification levels are possible in other examples.

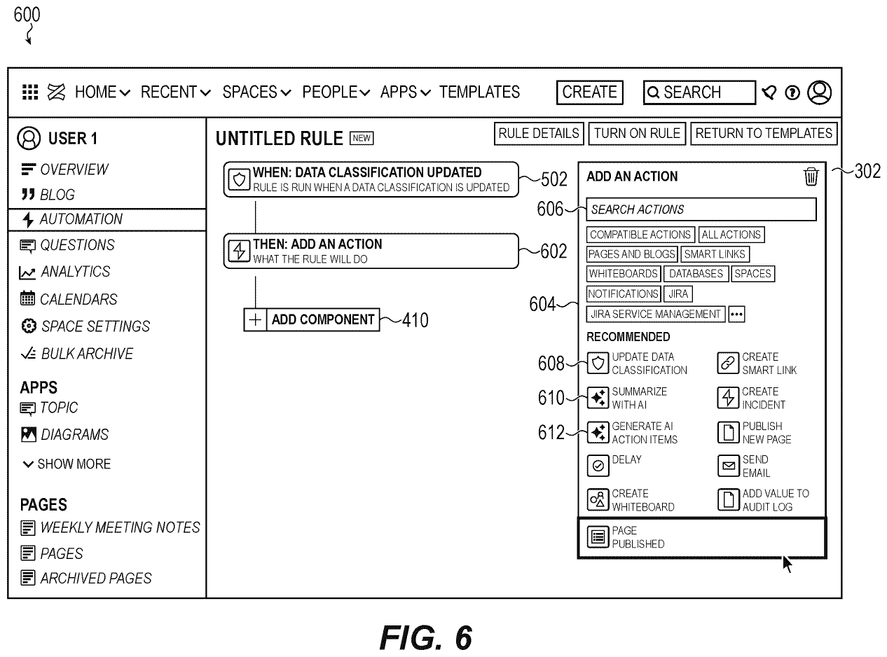

FIG. 6 shows an example frontend interface 600 that supports one or more aspects of automated data classification for collaboration platforms, in accordance with aspects described herein. Frontend interface 600 may be an example of frontend interface 400 or frontend interface 500 following selection by a user of a generic action component 602. Following selection, the generic action component 602 may be shown as part of the automation rule flow, and an action selection window 604 displayed adjacent the automation rule flow in the rule builder 302.

The action selection window 604 presents a set of action components that are available to be added to the automation rule. A search input field 606 may be used to search for and identify action components from the set of action components shown in action selection window 604. In some examples, an action component may be a classification action component, such as update data classification 608. In one or more examples, one or more action components may include action components that utilize a generative output engine, include an action to summarize content using a generative output engine (e.g., summarize with AI action 610) and an action to generate a set of action items from content using a generative output engine (e.g., generate AI action items action 612).

Generally, each action component of the set of action components in the action selection window 604 indicates the action to be performed following satisfaction of a trigger component (e.g., data classification updated 502), and satisfaction of a condition component (not shown), if any. The action indicates the object on which the action is performed. Actions are what the automation rule is to do or, stated differently, what happens if the automation rule executes successfully.

In some embodiments, the set of action components shown in action selection window 604 may be organized into one or more groups or subsets of action components. For example, the groups may include compatible actions, all action, pages and blogs, smart links, whiteboards, databases, spaces, notifications, Jira (e.g., an example of issue tracking system), Jira service management, and so on. For example, the recommended actions may include an updated data classification 608, summarize with AI action 610, generate AI action items action 612, delay, create whiteboard, page published, create smart link, create incident, publish new page, send email, or add value to audit log.

Other example action components that may be used consistent with the frontend interface 600 include a transition an issue in Jira, edit an issue in Jira, add a label, add a label using a generative output engine (e.g., “add label with AI”), change page status, create issue in Jira, publish a new page, restrict a page, or send an email. Examples of pages and blogs actions may include adding a comment, adding a label, archiving a page, change a page owner, change a page status, copy a page, delete a blog, delete a page, manage watchers, move a page, publish a new page, remove a label, or restrict a page. Examples of spaces actions may include archiving a space, creating a space, or granting space permissions. Examples of notification actions may include sending an email, sending a message through a first platform (e.g., a Microsoft Teams message), sending a message through a second platform (e.g., a Slack message), sending a message through a third platform (e.g., a Twilio notification), or send a web request. Examples of additional Jira actions may include transitioning an issue, editing an issue, or creating an issue. The advance actions include creating a lookup table, creating a variable, or logging an action. Other example actions of the set of action components in the action selection window 604 include one or more of page archiving, page ownership changing, page status changing, page copying, page deletion, page moving, new page publishing, page restriction, blog deletion, comment addition, label addition, label removing, watcher management, space permission adding, space archiving, or a combination of these. In some embodiments, these actions are for a documentation platform.

In one or more embodiments, actions of the set of action components in the action selection window 604 include one or more of email sending, application message sending, text message sending, web request sending, variable creation, action logging, or a combination of these. In some embodiments, these actions are for an issue tracking platform.

Search input field 606 (e.g., a search box) accepts textual inputs from a user, and in response, the rule builder 302 can filter the set of action components in the action selection window 604. In some embodiments, the displayed set of action components may be pared down such that only action components that satisfy the search are displayed (and other, non-responsive action components are hidden). In other embodiments, a drop-down or pop-up may be displayed that includes selectable action components that satisfy the search. In some examples, a set of actions that are compatible with or suggested for the user added to group trigger are provided in the set of action components in the action selection window 604. Such action components may include a send permissions email action, an update classification level action, a block public links action, a send welcome message action, or a create onboarding tasks action.

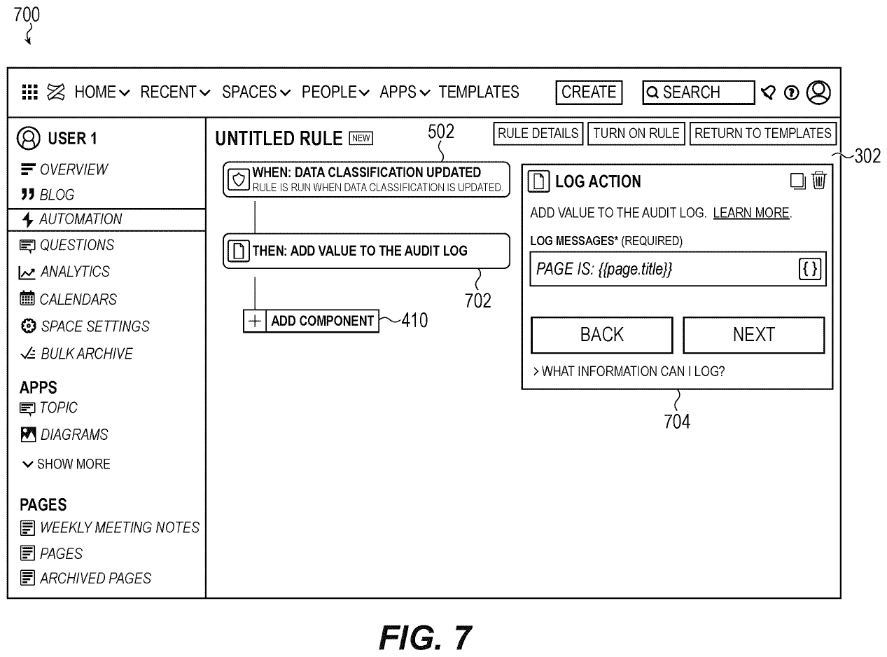

FIG. 7 depicts an example frontend interface 700 that supports one or more aspects of automated data classification for collaboration platforms, as further described herein. Frontend interface 700 may be an example of frontend interface 600 following selection by a user of an action component 702 to be performed in response to the data classification updated trigger component 502 that is triggered by the classification of an item of content being updated, as described with reference to frontend interface 600. The action component 702 is an action to add a value to an audit log responsive to the satisfaction of the trigger.

An action modification window 704 may be displayed, for example when a user selects to include an action component 702 in the automation rule. The action component is depicted as an action to add a value to an audit log, but any suitable action described herein may be used in other examples, including a classification action component 330. In the example of the action component 702, an action modification window 704 may provide one or more input fields to allow for the customization of the action component 702, the input fields configured to receive user input via text, or selection from a drop-down list or menu. In some examples dynamic references may be used, for example based on text or another value extracted from content that triggered the automation rule. In this example, a log message value to be added to the audit log may recite “PAGE IS: {{page. title}}” where {{page. title}} is a reference to the page title of the content page that triggered the automation rule.

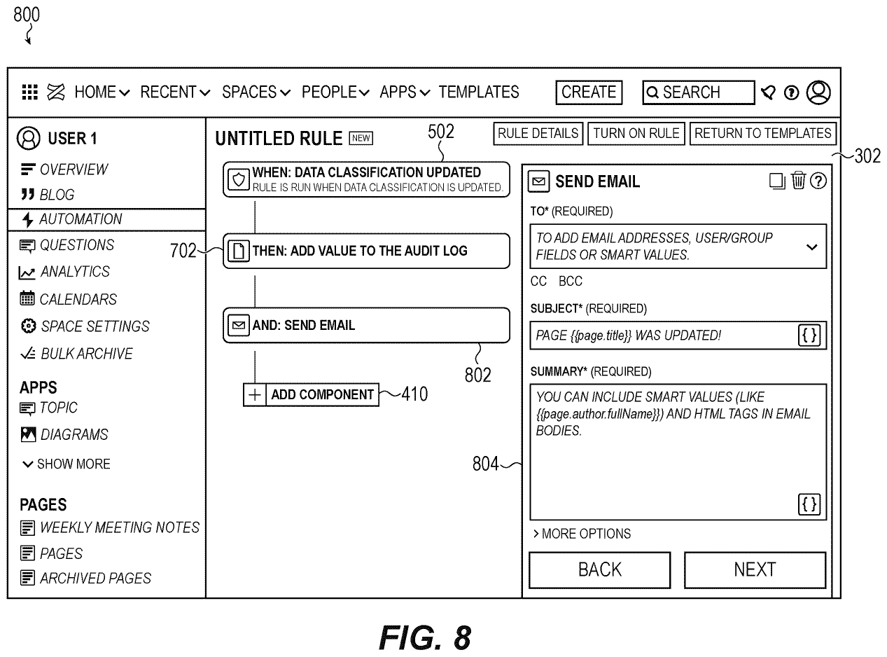

FIG. 8 depicts an example frontend interface 800 that supports one or more aspects of automated data classification for collaboration platforms, as further described herein. Frontend interface 800 may be an example of frontend interface 700 following selection by a user of an action component 802 to be performed in response to the data classification updated trigger component 502 and following the action component 702. The action component 802 is an action to send an email responsive to the satisfaction of the trigger.

An action modification window 804 may be displayed, for example when a user selects to include an action component 802 in the automation rule. The action component is depicted as an action to send an email, but any suitable action described herein may be used in other examples, including a classification action component 330. In the example of the action component 802, the action modification window 804 may provide one or more input fields to allow for the customization of the action component 802, the input fields configured to receive user input via text, or selection from a drop-down list or menu. The input fields for the email action may include a “to” field, a “subject” field, and a “summary” field. In some examples dynamic references may be used, for example based on text or another value extracted from content that triggered the automation rule. In this example, the subject line of the email to be sent may recite “PAGE {{page.title}} WAS UPDATED!” where {{page.title}} is a reference to the page title of the content page that triggered the automation rule. Similarly, the body (summary) of the email may use such dynamic references such as {{page.author.fullName}} to provide the full name of the author of the page that was updated to trigger the automation rule, or HTML tags.

FIG. 9 depicts another example frontend interface 900 that supports one or more aspects of automated data classification for collaboration platforms, as further described herein. Frontend interface 900 may be an example of frontend interface 600 following selection by a user of a condition component 910 to be performed in response to a trigger component 902 that is triggered by the publication of a page of content. Although the trigger component 902 is a page publication trigger, any suitable trigger component may be used, including classification trigger components. The condition component 910 is a condition component that utilizes a generative output engine.

A condition modification window 904 may be displayed, for example when a user selects to include the condition component 910 in the automation rule. The condition component is depicted as a condition using a generative output engine (e.g., an “AI condition”) to determine whether the content body (of the content that triggered the automation rule) is related to text, that is a parameter of the condition component 910. The condition modification window 904 includes an input field 906 to select a prompt and an input field 908 to provide text for the prompt. In the example of the condition component 910, a generative output engine (e.g., “AI”) is used to determine the relationship between content (e.g., the content that triggered the automation rule) and a word or phrase. The condition can reference the content using a dynamic reference (e.g., “smart value”) of “{{content}}” to determine the piece of content to act on (e.g., an item of content extracted from the electronic document, page, issue, and so on that triggered the automation rule).

In the example of input field 906 depicted for the frontend interface 900, the prompt is to determine “does content body relate to given text?” and the generative output engine determines whether the body of the content relates to the text indicated via the input field 908. In other examples, the input field 906 may indicate that the generative output engine determines whether the title of the content relates to the text indicated via the input field 908. In yet another example, other portions of content may be used for the comparison by the generative output engine.

In the example of input field 908 depicted for the frontend interface 900, the input text may be provided by a user as a text string. In other examples, a drop-down menu or autocomplete feature may be used. In some cases, the input 908 may provide a set of potential text selections to use for the input field 908. In some cases, the text may be context specific, where the type of trigger component selected for the automation rule may determine a set of potential text selections to use for the input field 908.

In some cases, and specifically with reference to a condition component 910 that is a classification condition component (e.g., classification condition component 320), the input field 908 may have a set of candidate classification levels provided or allowed to be entered by a user. Examples of classification levels that may be used herein include restricted, protected, confidential, internal, public, team-specific (e.g., space-specific, group-specific, and so on), editor-only (e.g., unpublished). A set of candidate classification levels may include one or more classification levels. A first example of such a set of classification levels may be “public” or “internal.” A second example set may include “unrestricted,” “confidential,” and “highly confidential.” A third example set may include “restricted,” “protected,” “confidential,” “internal,” and “public.” A fourth example set may include only “restricted,” where no classification level is a public or unrestricted level or designation. These are merely examples, and other sets of classification levels are contemplated consistent with the techniques described herein.

In one or more examples, the condition component 910 may utilize a generative output engine. For example, the AI condition 910 may be selectable to provide a condition component using the generative output engine. Examples of other condition components that may be used consistent with the techniques described herein (e.g., a classification trigger component and/or a classification action component) include a smart values condition 904, a CQL condition 908, an if-or-else condition 910, or a user condition 912.

FIG. 10 depicts an example frontend interface 1000 that supports one or more aspects of automated data classification for collaboration platforms, as further described herein. Frontend interface 1000 may be an example of frontend interface 400 following selection by a user of a trigger component 1020 that is triggered when a page is published and a condition component 1004 that applies a condition to compare two values. The condition component 1004 checks if the title of a page (the content that triggered the automation rule) contents meeting notes. In some examples, the condition component 1004 may be an example of a condition component 910 that uses a generative output engine. In other examples, the condition component 1004 may not use a generative output engine, for example performing a text string search or other operation not using a generative output engine.

The selection of an action component 1006 that is an updated data classification component may cause display of an action selection window 1010 for the action component 1006. An input field 1012 for the action selection window 1010 may allow for the indication of a classification level (new classification level) to which to update the content that triggered the automation rule (from the old classification level). As depicted the update may set the classification level according to the indicated level. In other examples, the update may be to increase the classification level by a certain number of levels in the classification scheme or hierarchy (e.g., up one level), or decrease the classification level by a certain number of levels in the classification scheme or hierarchy (e.g., down one level).

In the example of input field 1012 depicted for the frontend interface 1000, the input text may be provide by a user as a text string. In other examples, a drop-down menu or autocomplete feature may be used. In some cases, the input field 1012 may provide a set of potential text selections to use for the input field 1012. In some cases, the text may be context specific, where the type of trigger component selected for the automation rule may determine a set of potential text selections to use for the input field 1012.

In some cases, and specifically with reference to an action component 1006 that is a classification action component (e.g., classification action component 330), the input field 1012 may have a set of candidate classification levels provided or allowed to be entered by a user. A first example of such a set of classification levels may be “public” or “internal.” A second example set may include “unrestricted,” “confidential,” and “highly confidential.” A third example set may include “restricted,” “protected,” “confidential,” “internal,” and “public.” A fourth example set may include only “restricted,” where no classification level is a public or unrestricted level or designation. These are merely examples, and other sets of classification levels are contemplated consistent with the techniques described herein.

FIG. 11 depicts an example frontend interface 1100 that provides an interface to a generative output engine to generate an automation rule. The generated automation rule may use one or more of the classification trigger component 310, the classification condition component 320, or the classification action component 330 as further described herein.

The frontend interface 1100 may be caused to be displayed from one or more of the collaboration platforms described herein. In some examples, a user selection of a selectable graphical element 1102 (“button”) may cause display of a window 1104 for the interface to a generative output engine to generate the automation rule. In one example, an input field 1108 may allow for a user to enter text. In the example depicted, a user has entered “when classification is updated on a page, I want to add a comment that says ‘OK’.” In some examples, a user may select to preview the automation rule (using the graphical element 1112) that will be generated (e.g., by the generative output engine) responsive to the user input to the input field 1108. Such an automation rule may then be displayed to a user with a classification trigger component and an action component. The classification trigger component may be, for example, the graphical element 502 representing the data classification update described with reference to the frontend interface 500. The action component may be a content update action component that adds a comment to the content that triggered the automation rule (the page whose classification was updated) that states “OK.”

The preview of the rule may be in the form of a draft automation rule (not shown) similar to the format or in the frontend interface of the rule builder 302 (e.g., similar to one or more of the frontend interfaces 400 through 1000). From the draft automation rule, a user may select to save the draft automation rule, whereupon the system 100 (e.g., the centralized automation rule service 112) may generate a service based on the automation rule and/or save the automation rule to the database 118.

In some examples, a user may select (using the graphical element 1112) to be shown an example of text strings or other inputs that may be provided to the input field 1108 that successfully results in draft automation rules from the generative output engine.

The input field 1108 may be or provide a conversation interface (e.g., a conversational AI interface). The conversational interface may be a natural language user interface (NLUI) or conversational user interface (CUI). In some examples, the conversation interface of input field 1108 is designed to simulate natural, human-like dialogue by interpreting user inputs in plain text. The conversation interface may rely on natural language understanding (NLU) and be configured to receive and handle diverse linguistic styles, phrasing, and context. In some examples, the conversation interface may incorporate a dialog flow, enabling it to maintain context across exchanges and adapt responses based on user intent and previous interactions. In some examples, the input field 1108 may be contextually aware, such that the generated automation rules may be adapted based on inputs.

In some examples, the automation rules that result from inputs to the conversation interface of the input field 1108 may be based at least in part on a profile of a user that is entering the text into the input field 1108. For example, the generated automation rules may be based on member of the user in a group, a permission profile of the user, the collaboration platform from which the window 1104 showing the input field 1108 is launched or accessed, a subscription or subscription level of the user, and so on.

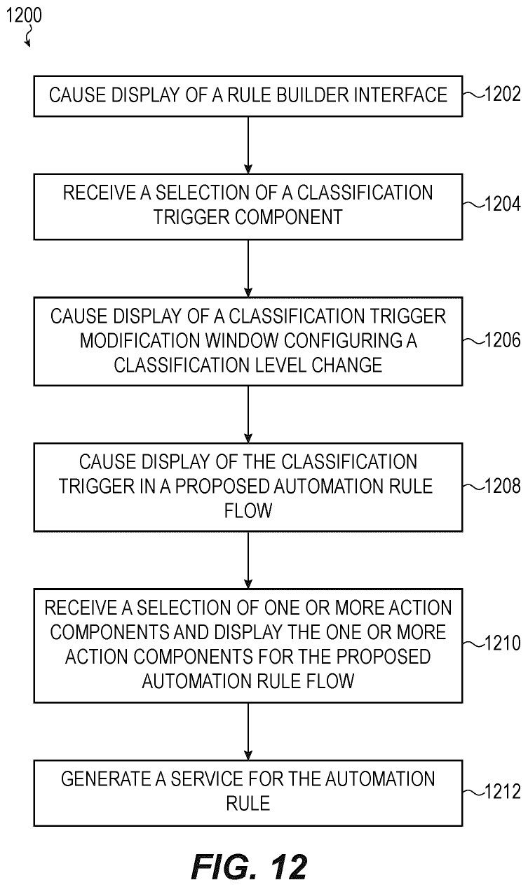

FIG. 12 depicts an example method 1200 according to one or more aspects described herein. In one or more embodiments, method 1200 supports one or more aspects of automated data classification for collaboration platforms, as further described herein. In some examples, method 1200 is a computer-implemented method for updating or generating content using dynamic automation rule buttons within a collaboration system. The method 1200 may be performed using one or more processors, memory, or other components or resource allocations of the collaboration system, including one or more collaboration platforms (e.g., a collaboration platform associated with first platform backend 108 and/or a collaboration platform associated with second platform backend 110), or the centralized automation rule service 112, including corresponding resources thereof.

At 1202, the method 1200 includes causing display of a rule builder interface. In some embodiments, the method 1200 includes causing display of a rule builder graphical user interface of a frontend of the collaboration system, the rule builder graphical user interface including a rule component selection user element.

At 1204, the method 1200 includes receiving a selection of a classification trigger component. In some embodiments, the method 1200 includes in response to receiving a selection of the rule component selection user element for an automation rule, causing display of a trigger selection window for a set of candidate trigger components for the automation rule, the set of candidate trigger components including a classification trigger component.

At 1206, the method 1200 includes causing display of a classification trigger modification window configuring a classification level change. In some embodiments, the method 1200 includes subsequent to receiving a first input of the rule builder graphical user interface selecting the classification trigger component for the automation rule, causing display of a classification trigger modification window that includes at least an input field to indicate a classification level change for an electronic document associated with the classification trigger component.

At 1208, the method 1200 includes causing display of the classification trigger in a proposed automation rule flow. In some embodiments, the method 1200 includes subsequent to a user input to the input field indicating the classification level change, causing display of a first one or more graphical elements representing the classification trigger component in a proposed automation rule flow.

At 1210, the method 1200 includes receiving a selection of one or more action components and displaying the one or more action components for the proposed automation rule flow. In some embodiments, the method 1200 includes in response to receiving a second input of the rule builder graphical user interface selecting one or more action components for the automation rule, causing display of a second one or more graphical elements representing the one or more action components in the proposed automation rule flow.

At 1212, the method 1200 includes generating a service for the automation rule. In some embodiments, the method 1200 includes generating a service on the collaboration system that performs an operation on an object in response to an event satisfying a criteria of the classification trigger component of the automation rule, the operation corresponding to the one or more action components.

In some embodiments, the electronic document is hosted on a first collaboration platform and owned by an authenticated user, and the service further performs obtaining a permission profile of a second user that owns the object, the object hosted on a second collaboration platform; and in response to verifying the permission profile of the second user, performing the operation on the object at the second collaboration platform.

In some embodiments, the classification trigger component is configured to utilize a generative output engine to determine that the event satisfies the criteria of the classification trigger component, the determination based at least in part on content extracted from the electronic document.

In some embodiments, the electronic document is associated with a document management platform of the collaboration system; and the classification level change is from an old classification level to a new classification level, where the old classification level includes one of a restricted, a protected, a confidential, an internal, or a public classification level, and the new classification level includes a different one of the restricted, the protected, the confidential, the internal, or the public classification level.

In some embodiments, the classification trigger component is associated with the event at a first collaboration platform of the collaboration system; and the one or more action components are associated with a second collaboration platform of the collaboration system, the object hosted on the second collaboration platform.

The method 1200 may be variously embodied, extended, or adapted, as described in the following paragraphs and elsewhere in this description.

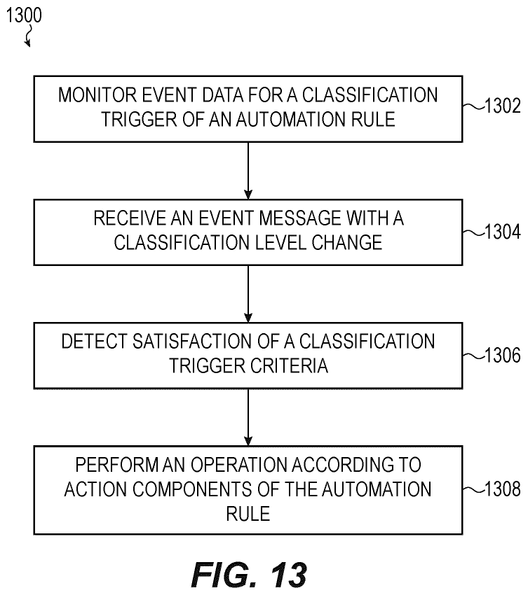

FIG. 13 depicts an example method 1300 according to one or more aspects described herein. In one or more embodiments, method 1300 supports one or more aspects of automated data classification for collaboration platforms, as further described herein. In some examples, method 1300 is a computer-implemented method for updating or generating content using dynamic automation rule buttons within a collaboration system. The method 1300 may be performed using one or more processors, memory, or other components or resource allocations of the collaboration system, including one or more collaboration platforms (e.g., a collaboration platform associated with first platform backend 108 and/or a collaboration platform associated with second platform backend 110), or the centralized automation rule service 112, including corresponding resources thereof.

At 1302, the method 1300 includes monitoring event data for a classification trigger of an automation rule. In some embodiments, the method 1300 includes monitoring a set of event data of the collaboration system according to a classification trigger component of an automation rule.

At 1304, the method 1300 includes receiving an event message with a classification level change. In some embodiments, the method 1300 includes in response to monitoring the set of event data, receiving an event message associated with a classification level change for an electronic document from an old classification level to a new classification level, the electronic document associated with an object hosted on the collaboration system.

At 1306, the method 1300 includes detecting satisfaction of a classification trigger criteria. In some embodiments, the method 1300 includes in response to a determination that the classification level change satisfies a criteria of the classification trigger component, identify one or more action components of the automation rule.

At 1308, the method 1300 includes performing an operation according to action components of the automation rule. In some embodiments, the method 1300 includes subsequent to the identification of the one or more action components, performing an operation on the object hosted on the collaboration system, the operation corresponding to the one or more action components.

In one or more embodiments, the method further includes in response to receiving the event message, extracting content from the electronic document; generating a content classification prompt including the extracted content, an indication of the new classification level, and one or more exemplary content-classification pairs; providing the content classification prompt to a generative output engine; obtaining, from the generative output engine, a generative response that indicates that the electronic document is associated with the new classification level; and determining, based at least in part on the generative response that indicates the new classification level, that the classification level change satisfies the criteria of the classification trigger component. In some embodiments, the event message indicates the new classification level for the electronic document, the method further including, in response to determining that the new classification level indicated by the event message matches the new classification level indicated by the generative response, determining to proceed to perform the operation. In some embodiments, the event message indicates the new classification level for the electronic document, the method further including, in response to determining that the new classification level indicated by the event message is inconsistent with the new classification level indicated by the generative response, perform a classification review operation prior to performing the operation on the object hosted on the collaboration system.

In one or more embodiments, the method further includes subsequent to the identification of the one or more action components, determining whether the classification level change is from a less restrictive classification level to a relatively more restrictive classification level; in response to determining that the classification level change is from the less restrictive classification level to the relatively more restrictive classification level, proceeding to perform the operation on the object hosted on the collaboration system; and in response to determining that the classification level change is from a more restrictive classification level to a relatively less restrictive classification level, transmit a message requesting authorization to perform the operation and, in response to receiving the authorization, proceeding to perform the operation on the object hosted on the collaboration system.

In one or more embodiments, the method further includes identifying, in the electronic document, first content of the electronic document and a link to another content item; extracting second content from another content item; and determining that the criteria of the classification trigger component is satisfied based at least in part on the first content and the second content. In some embodiments, the electronic document includes an issue item of an issue tracking platform of the collaboration system; and another content item includes a page of a documentation platform of the collaboration system, the link to another content item including the link to the page of the documentation platform.

The method 1300 may be variously embodied, extended, or adapted, as described in the following paragraphs and elsewhere in this description.

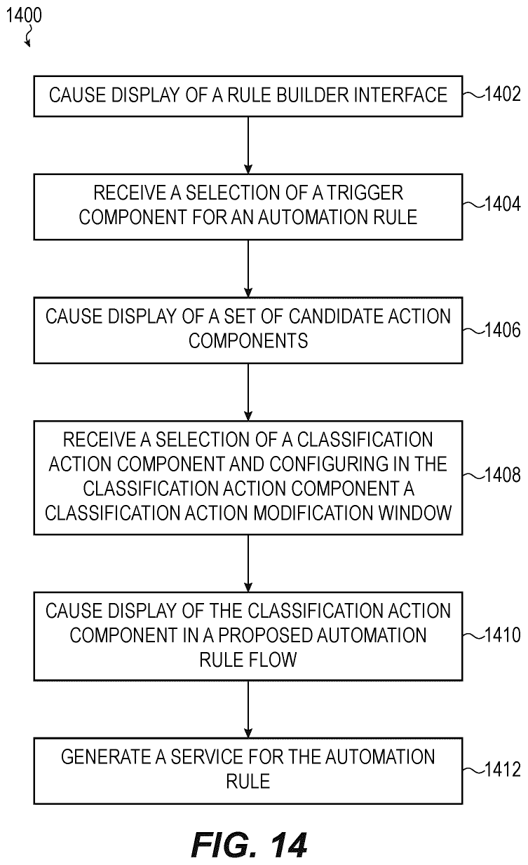

FIG. 14 depicts an example method 1400 according to one or more aspects described herein. In one or more embodiments, method 1400 supports one or more aspects of automated data classification for collaboration platforms, as further described herein. In some examples, method 1400 is a computer-implemented method for updating or generating content using dynamic automation rule buttons within a collaboration system. The method 1400 may be performed using one or more processors, memory, or other components or resource allocations of the collaboration system, including one or more collaboration platforms (e.g., a collaboration platform associated with first platform backend 108 and/or a collaboration platform associated with second platform backend 110), or the centralized automation rule service 112, including corresponding resources thereof.

At 1402, the method 1400 includes causing display of a rule builder interface. In some embodiments, the method 1400 includes causing display of a rule builder graphical user interface of a frontend of the collaboration system, the rule builder graphical user interface including a rule component selection user element.

At 1404, the method 1400 includes receiving a selection of a trigger component for an automation rule. In some embodiments, the method 1400 includes in response to receiving a first input of the rule builder graphical user interface selecting a trigger component for an automation rule, causing display of a first one or more graphical elements representing the trigger component in a proposed automation rule flow.

At 1406, the method 1400 includes causing display of a set of candidate action components. In some embodiments, the method 1400 includes in response to receiving a selection of the rule component selection user element for the automation rule, causing display of a selection window for a set of candidate action components for the automation rule, the set of candidate action components including a classification action component.

At 1408, the method 1400 includes receiving a selection of a classification action component and configuring in the classification action component a classification action modification window. In some embodiments, the method 1400 includes subsequent to receiving a second input of the rule builder graphical user interface selecting the classification action component for the automation rule, causing display of a classification action modification window that includes at least an input field to indicate a classification level for an electronic document associated with the classification action component.

At 1410, the method 1400 includes causing display of the classification action component in a proposed automation rule flow. In some embodiments, the method 1400 includes subsequent to a user input to the input field indicating the classification level, causing display of a second one or more graphical elements representing the classification action component in the proposed automation rule flow.

At 1412, the method 1400 includes generating a service for the automation rule. In some embodiments, the method 1400 includes generating a service on the collaboration system that performs an operation on an object in response to an event satisfying a criteria of the trigger component of the automation rule, the operation corresponding to the classification action component.

In some embodiments, the electronic document is hosted on a first collaboration platform of the collaboration system and owned by an authenticated user, and the service further performs obtaining a permission profile of a second user that owns the object, the object hosted on a second collaboration platform; and in response to verifying the permission profile of the second user, performing the operation on the object at the second collaboration platform.

In some embodiments, the operation corresponding to the classification action component includes modifying one or more permissions for the object.

In some embodiments, the object is associated with a page or a document of a documentation platform of the collaboration system, or an issue or a task of an issue tracking platform of the collaboration system.

The method 1400 may be variously embodied, extended, or adapted, as described in the following paragraphs and elsewhere in this description.

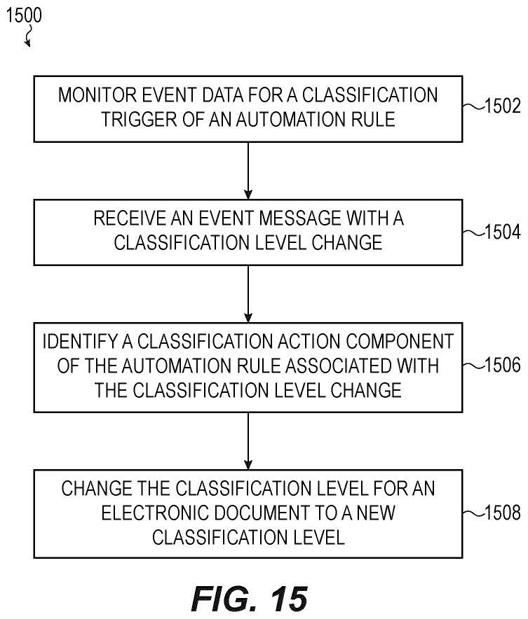

FIG. 15 depicts an example method 1500 according to one or more aspects described herein. In one or more embodiments, method 1500 supports one or more aspects of automated data classification for collaboration platforms, as further described herein. In some examples, method 1500 is a computer-implemented method for updating or generating content using dynamic automation rule buttons within a collaboration system. The method 1500 may be performed using one or more processors, memory, or other components or resource allocations of the collaboration system, including one or more collaboration platforms (e.g., a collaboration platform associated with first platform backend 108 and/or a collaboration platform associated with second platform backend 110), or the centralized automation rule service 112, including corresponding resources thereof.

At 1502, the method 1500 includes monitoring event data for a classification trigger of an automation rule. In some embodiments, the method 1500 includes monitoring a set of event data of the collaboration system according to a trigger component of an automation rule.

At 1504, the method 1500 includes receiving an event message with a classification level change. In some embodiments, the method 1500 includes in response to monitoring the set of event data, receiving an event message that satisfies a criteria of the trigger component for an electronic document associated with an object hosted on the collaboration system.

At 1506, the method 1500 includes identifying a classification action component of the automation rule associated with the classification level change. In some embodiments, the method 1500 includes subsequent to receive the event message, identifying one or more action components of the automation rule, the one or more action components including a classification action component that is associated with a classification level change.

At 1508, the method 1500 includes changing the classification level for an electronic document to a new classification level. In some embodiments, the method 1500 includes subsequent to the identification of the one or more action components, performing an operation on the object hosted on the collaboration system, the operation including the classification level change for the electronic document from an old classification level to a new classification level.

In one or more embodiments, the method further includes subsequent to the identification of the one or more action components, determining whether the classification level change is from a less restrictive classification level to a relatively more restrictive classification level; in response to determining that the classification level change is from the less restrictive classification level to the relatively more restrictive classification level, proceeding to perform the operation on the object hosted on the collaboration system; and in response to determining that the classification level change is from a more restrictive classification level to a relatively less restrictive classification level, transmit a message requesting authorization to perform the operation and, in response to receiving the authorization, proceeding to perform the operation on the object hosted on the collaboration system.

In one or more embodiments, the method further includes in response to a determination that the classification action component operates on the object, obtaining a permission profile of a second user that owns the object, the object hosted on a second collaboration platform of the collaboration system; verifying the permission profile with respect to the operation to be performed on the object hosted by the second collaboration platform; and in response to verifying the permission profile of the second user, performing the operation on the object at the second collaboration platform.

In some embodiments, the operation on the object that includes the classification level change includes transmitting, to a security service, a message requesting the classification level change for the electronic document; and in response to the transmitted message, receiving an acknowledgment message indicating that the classification level change has been performed at the security service.

The method 1500 may be variously embodied, extended, or adapted, as described in the following paragraphs and elsewhere in this description.

Embodiments contemplated herein include one or more non-transitory computer-readable media storing instructions to cause an electronic device, upon execution of the instructions by one or more processors (e.g., processing unit 1802) of the electronic device (e.g., electronic device 1800), to perform one or more elements of the method 1200, 1300, 1400, or 1500. Embodiments contemplated herein include an apparatus having logic, modules, or circuitry to perform one or more elements of the method 1200, 1300, 1400, or 1500. Embodiments contemplated herein include an apparatus having one or more processors (e.g., processing unit 1802) and one or more computer-readable media (e.g., memory 1804), using or storing instructions that, when executed by the one or more processors, cause the one or more processors to perform one or more elements of the method 1200, 1300, 1400, or 1500. Embodiments contemplated herein include a signal as described in or related to one or more elements of the method 1200, 1300, 1400, or 1500. Embodiments contemplated herein include a computer program or computer program product (e.g., memory 1804) having instructions, wherein execution of the program by a processor (e.g., processing unit 1802) causes the processor to carry out one or more elements of the method 1200, 1300, 1400, or 1500.

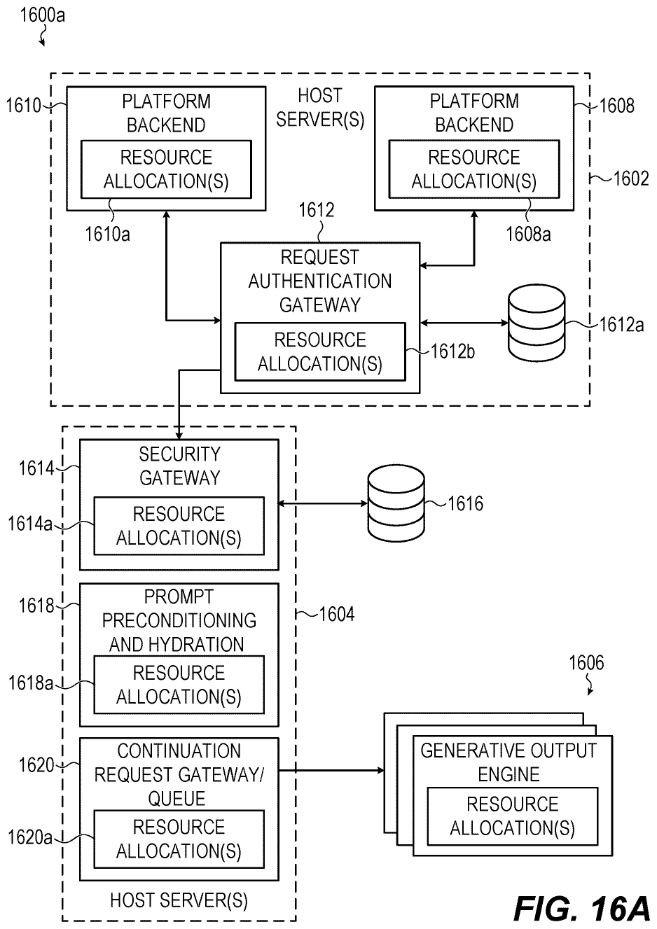

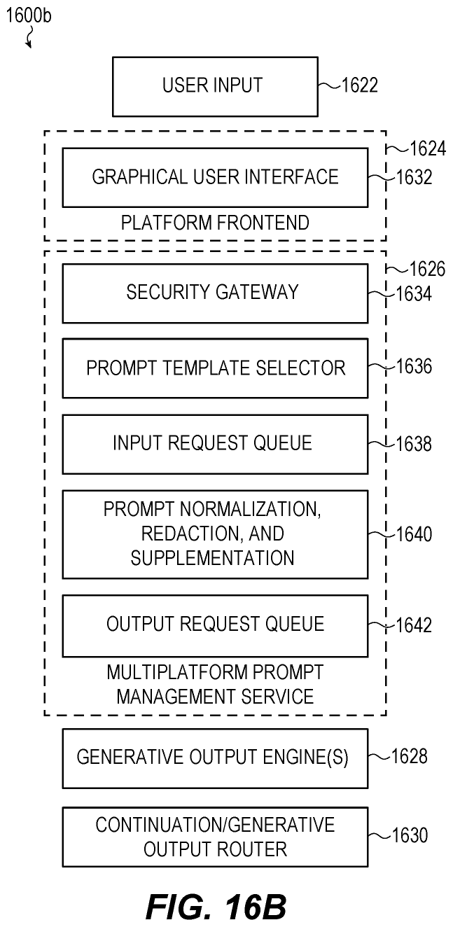

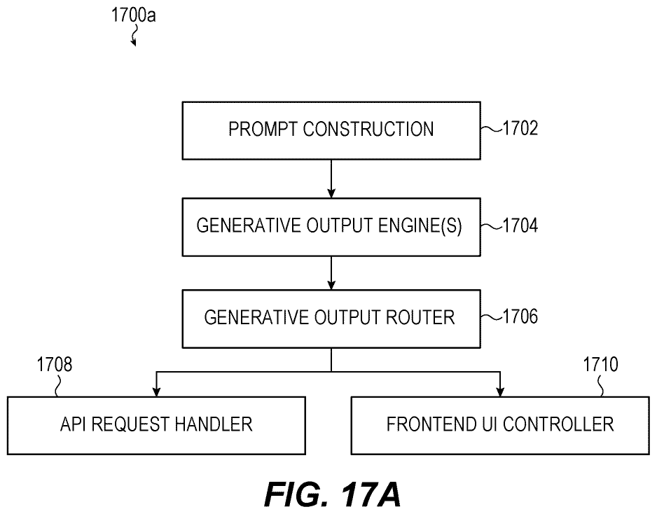

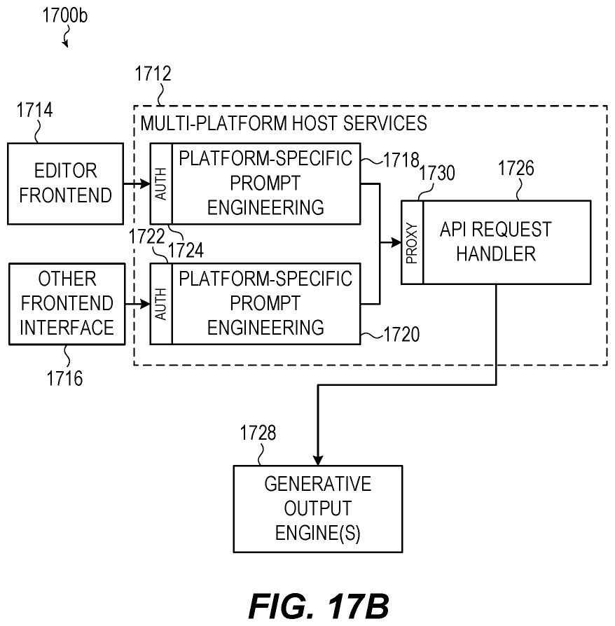

The generative services described herein may be implemented using a networked computing system, as described above with respect to FIG. 1 and other examples, herein. FIGS. 16A-17B describe additional components and functionality that may be used to produce generative content for one or more of the generative interfaces, described herein. Referring to FIG. 16A, the system 1600a includes a first set of host servers 1602 associated with one or more software platform backends. These software platform backends can be communicably coupled to a second set of host servers 1604 purpose configured to process requests and responses to and from one or more generative output engines 1606. Specifically, the first set of host servers 1602 (which, as described above can include processors, memory, storage, network communications, and any other suitable physical hardware cooperating to instantiate software) can allocate certain resources to instantiate a first and second platform backend, such as a first platform backend 1608 and a second platform backend 1610. Each of these respective backends can be instantiated by cooperation of processing and memory resources associated to each respective backend. As illustrated, such dedicated resources are identified as the resource allocations 1608a and the resource allocations 1610a.

Each of these platform backends can be communicably coupled to an authentication gateway 1612 configured to verify, by querying a permissions table, directory service, or other authentication system (represented by the database 1612a) whether a particular request for generative output from a particular user is authorized. Specifically, the second platform backend 1610 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 1612 can deny the request for insufficient permissions. This example is merely one and is not intended to be limiting and many possible authorization and authentication operations can be performed by the authentication gateway 1612. The authentication gateway 1612 may be supported by physical hardware resources, such as a processor and memory, represented by the resource allocations 1612b.

Once the authentication gateway 1612 determines that a request from a user of either platform is authorized to access data or resources implicated in service that request, the request may be passed to a security gateway 1614, which may be a software instance supported by physical hardware identified in FIG. 16A as the resource allocations 1614a. The security gateway 1614 may be configured to determine whether the request itself conforms to one or more policies or rules (data and/or executable representations of which may be stored in a database 1616) established by the organization. For example, the organization may prohibit executing prompts for offensive content, value-incompatible content, personally identifying information, health information, trade secret information, unreleased product information, secret project information, and the like. In other cases, a request may be denied by the security gateway 1614 if the prompt requests beyond a threshold quantity of data.

Once a particular user-initiated prompt has been sufficiently authorized and cleared against organization-specific generative output rules, the request/prompt can be passed to a plugin service 1618 configured to populate request-contextualizing data (e.g., user ID, page ID, project ID, URLs, addresses, times, dates, date ranges, and so on), insert the user's request into a larger engineered template prompt and so on. The plugin service 1618 may also be referred to as a prompt preconditioning and rehydration service. Example operations of plugin or other preconditioning instance are described elsewhere herein; this description is not repeated. The plugin service 1618 can be a software instance supported by physical hardware represented by the resource allocations 1618a. In some implementations, the plugin service 1618 may also be used to rehydrate personally identifiable information (PII) or other potentially sensitive data that has been extracted from a request or data exchange in the system.

Once a prompt has been modified, replaced, or hydrated by the plugin service 1618, it may be passed to an output gateway 1620 (also referred to as a continuation gateway or an output queue). The output gateway 1620 may be responsible for enqueuing and/or ordering different requests from different users or different software platforms based on priority, time order, or other metrics. The output gateway 1620 can also serve to meter requests to the generative output engines 1606.

FIG. 16B depicts a functional system diagram of the system 1600a depicted in FIG. 16A. In particular, the system 1600b is configured to operate as a multiplatform prompt management service supporting and ordering requests from multiple users across multiple platforms. In particular, a user input 1622 may be received at a platform frontend 1624. The platform frontend 1624 passes the input to a prompt management service 1626 that formalizes a prompt suitable for input to a generative output engine 1628, which in turn can provide its output to an output router 1630 that may direct generative output to a suitable destination. All or some of the operations performed by the prompt management service 1626 may be performed by a plugin that has been selected from a set of registered plugins based a context associated with a request and/or an intent analysis performed with respect to a user input.

In one example implementation, the output router 1630 may execute API requests generated by the generative output engine 1628, may submit text responses back to the platform frontend 1624, may wrap a text output of the generative output engine 1628 in an API request to update a backend of the platform associated with the platform frontend 1624, or may perform other operations. Specifically, the user input 1622 (which may be an engagement with a button, typed text input, spoken input, chat box input, and the like) can be provided to a graphical user interface 1632 of the platform frontend 1624. The graphical user interface 1632 can be communicably coupled to a security gateway 1634 of the prompt management service 1626 that may be configured to determine whether the user input 1622 is authorized to execute and/or complies with organization-specific rules.

The security gateway 1634 may provide output to a prompt selector 1636 which can be configured to select a prompt template from a database of preconfigured prompts, templatized prompts, or engineered templatized prompts. Once the raw user input is transformed into a string prompt, the prompt may be provided as input to a request queue 1638 that orders different user request for input from the generative output engine 1628. Output of the request queue 1638 can be provided as input to a prompt hydrator 1640 configured to populate template fields, add context identifiers, supplement the prompt, and perform other normalization operations described herein. In other cases, the prompt hydrator 1640 can be configured to segment a single prompt into multiple discrete requests, which may be interdependent or may be independent. Thereafter, the modified prompt(s) can be provided as input to an output queue at 1642 that may serve to meter inputs provided to the generative output engine 1628.

These foregoing embodiments depicted in FIGS. 16A-16B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein.

For example, although many constructions are possible, FIG. 17A depicts a simplified system diagram and data processing pipeline as described herein. The system 1700a receives user input, and constructs a prompt therefrom at operation 1702. After constructing a suitable prompt, and populating template fields, selecting appropriate instructions and examples for an LLM to continue, the modified constructed prompt is provided as input to a generative output engine 1704. A continuation from the generative output engine 1704 is provided as input to a router 1706 configured to classify the output of the generative output engine 1704 as being directed to one or more destinations. For example, the router 1706 may determine that a particular generative output is an API request that should be executed against a particular API (e.g., such as an API of a system or platform as described herein). In this example, the router 1706 may direct the output to an API request handler 1708. In another example, the router 1706 may determine that the generative output may be suitably directed to a graphical user interface/frontend handled by a frontend UI controller 1710. For example, a generative output may include suggestions to be shown to a user below a user's partial input.

Another example architecture is shown in FIG. 17B, illustrating a system providing prompt management, and in particular multiplatform prompt management as a service. The system 1700b is instantiated over cloud resources, which may be provisioned from a pool of resources in one or more locations (e.g., datacenters). In the illustrated embodiment, the provisioned resources are identified as the multi-platform host services 1712.

The multi-platform host services 1712 can receive input from one or more users in a variety of ways. For example, some users may provide input via an editor region 1714 of a frontend, such as described above. Other users may provide input by engaging with other user interface elements 1716 unrelated to common or shared features across multiple platforms. Specifically, the second user may provide input to the multi-platform host services 1712 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 1712 can include multiple software instances or microservices each configured to receive user inputs and/or proposed prompts and configured to provide, as output, an engineered prompt. In many cases, these instances—shown in the figure as the platform-specific prompt engineering services 1718, 1720—can be configured to wrap proposed prompts within engineered prompts retrieved from a database such as described above.

In many cases, the platform-specific prompt engineering services 1718, 1720 can be each configured to authenticate requests received from various sources. In other cases, requests from editor regions or other user interface elements of particular frontends can be first received by one or more authenticator instances, such as the authentication instances 1722, 1724. In other cases, a single centralized authentication service can provide authentication as a service to each request before it is forwarded to the platform-specific prompt engineering services 1718, 1720.

Once a prompt has been engineered/supplemented by one of the platform-specific prompt engineering services 1718, 1720, it may be passed to a request queue/API request handler 1726 configured to generate an API request directed to a generative output engine 1728 including appropriate API tokens and the engineered prompt as a portion of the body of the API request. In some cases, a service proxy 1730 can interpose the platform-specific prompt engineering services 1718, 1720 and the request queue/API request handler 1726, so as to further modify or validate prompts prior to wrapping those prompts in an API call to the generative output engine 1728 by the request queue/API request handler 1726 although this is not required of all embodiments.

These foregoing embodiments depicted in FIGS. 17A-17B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein.

More generally, it may be appreciated that a multiplatform system as described herein can include a centralized gateway configured to manage requests for generative output across multiple platforms. For example, the centralized gateway (which can precondition prompts, generate prompts, modify prompts, postprocess generative output, handle recursive generative output in which a first generative output is used to produce a second generative output, and so on) can be configured to determine priority of different requests for generative output across multiple systems. For example, certain users or certain roles or certain types of requests for generative output may be prioritized higher by the centralized system and serviced first. In other cases, the centralized system may be configured to rate limit particular users, particular platforms, particular roles, and/or particular request types for a number of suitable reasons (e.g., to comply with generative output system API call limitations, to ensure even treatment across multiple platforms, and so on). In other cases, a centralized gateway can be configured to enforce compliance with one or more policies (e.g., policies limiting particular kinds of generative output, policies for information sharing, personal information dissemination policies, and so on). In yet other cases, a centralized gateway can be used to manage or load balance between multiple different LLMs.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Other conditions or controls may also be applied to the system in order to facilitate reliable and consistent usage of shared resources.

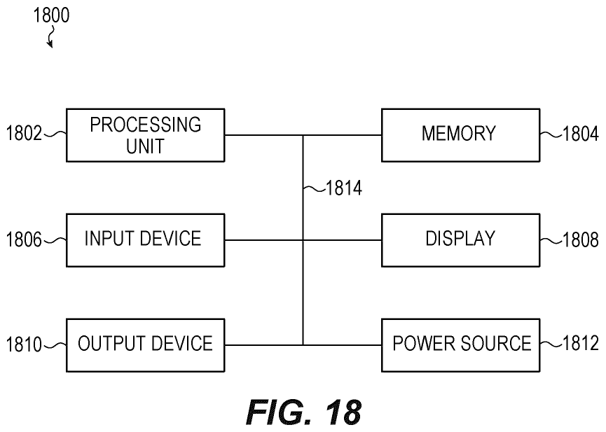

FIG. 18 depicts a sample electrical block diagram of an electronic device 1800 that may perform the operations described herein. The electronic device 1800 may in some cases take the form of any of the electronic devices described with reference to FIGS. 1-17, including client devices, and/or servers or other computing devices associated with the system 100. The electronic device 1800 can include one or more of a processing unit 1802, a memory 1804 or storage device, input devices 1806, a display 1808, output devices 1810, and a power source 1812. In some cases, various implementations of the electronic device 1800 may lack some or all of these components and/or include additional or alternative components.

The processing unit 1802 can control some or all of the operations of the electronic device 1800. The processing unit 1802 can communicate, either directly or indirectly, with some or all of the components of the electronic device 1800. For example, a system bus or other communication mechanism 1814 can provide communication between the processing unit 1802, the power source 1812, the memory 1804, the input device(s) 1806, and the output device(s) 1810.

The processing unit 1802 can be implemented as any electronic device capable of processing, receiving, or transmitting data or instructions. For example, the processing unit 1802 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1800 can be controlled by multiple processing units. For example, select components of the electronic device 1800 (e.g., an input device 1806) may be controlled by a first processing unit and other components of the electronic device 1800 (e.g., the display 1808) may be controlled by a second processing unit, where the first and second processing units may or may not be in communication with each other.

The power source 1812 can be implemented with any device capable of providing energy to the electronic device 1800. For example, the power source 1812 may be one or more batteries or rechargeable batteries. Additionally, or alternatively, the power source 1812 can be a power connector or power cord that connects the electronic device 1800 to another power source, such as a wall outlet.

The memory 1804 can store electronic data that can be used by the electronic device 1800. For example, the memory 1804 can store electronic data or content such as, for example, audio and video files, documents and applications, device settings and user preferences, timing signals, control signals, and data structures or databases. The memory 1804 can be configured as any type of memory. By way of example only, the memory 1804 can be implemented as random access memory, read-only memory, flash memory, removable memory, other types of storage elements, or combinations of such devices.

In some examples, the processing unit 1802 may be configured to, and/or the memory 1804 may store instructions that when executed by the processing unit 1802 cause the electronic device 1800 to, perform causing display of a rule builder graphical user interface of a frontend of the collaboration system, the rule builder graphical user interface including a rule component selection user element; in response to receiving a selection of the rule component selection user element for an automation rule, causing display of a trigger selection window for a set of candidate trigger components for the automation rule, the set of candidate trigger components including a classification trigger component; subsequent to receiving a first input of the rule builder graphical user interface selecting the classification trigger component for the automation rule, causing display of a classification trigger modification window that includes at least an input field to indicate a classification level change for an electronic document associated with the classification trigger component; subsequent to a user input to the input field indicating the classification level change, causing display of a first one or more graphical elements representing the classification trigger component in a proposed automation rule flow; in response to receiving a second input of the rule builder graphical user interface selecting one or more action components for the automation rule, causing display of a second one or more graphical elements representing the one or more action components in the proposed automation rule flow; and generating a service on the collaboration system that performs an operation on an object in response to an event satisfying a criteria of the classification trigger component of the automation rule, the operation corresponding to the one or more action components.

In other examples, the processing unit 1802 may be configured to, and/or the memory 1804 may store instructions that when executed by the processing unit 1802 cause the electronic device 1800 to, perform monitoring a set of event data of the collaboration system according to a classification trigger component of an automation rule; in response to monitoring the set of event data, receiving an event message associated with a classification level change for an electronic document from an old classification level to a new classification level, the electronic document associated with an object hosted on the collaboration system; in response to a determination that the classification level change satisfies a criteria of the classification trigger component, identify one or more action components of the automation rule; and subsequent to the identification of the one or more action components, performing an operation on the object hosted on the collaboration system, the operation corresponding to the one or more action components.

In other examples, the processing unit 1802 may be configured to, and/or the memory 1804 may store instructions that when executed by the processing unit 1802 cause the electronic device 1800 to, perform causing display of a rule builder graphical user interface of a frontend of the collaboration system, the rule builder graphical user interface including a rule component selection user element; in response to receiving a first input of the rule builder graphical user interface selecting a trigger component for an automation rule, causing display of a first one or more graphical elements representing the trigger component in a proposed automation rule flow; in response to receiving a selection of the rule component selection user element for the automation rule, causing display of an selection window for a set of candidate action components for the automation rule, the set of candidate action components including a classification action component; subsequent to receiving a second input of the rule builder graphical user interface selecting the classification action component for the automation rule, causing display of a classification action modification window that includes at least an input field to indicate a classification level for an electronic document associated with the classification action component; subsequent to a user input to the input field indicating the classification level, causing display of a second one or more graphical elements representing the classification action component in the proposed automation rule flow; and generating a service on the collaboration system that performs an operation on an object in response to an event satisfying a criteria of the trigger component of the automation rule, the operation corresponding to the classification action component.

In other examples, the processing unit 1802 may be configured to, and/or the memory 1804 may store instructions that when executed by the processing unit 1802 cause the electronic device 1800 to, perform monitoring a set of event data of the collaboration system according to a trigger component of an automation rule; in response to monitoring the set of event data, receiving an event message that satisfies a criteria of the trigger component for an electronic document associated with an object hosted on the collaboration system; subsequent to receive the event message, identifying one or more action components of the automation rule, the one or more action components including a classification action component that is associated with a classification level change; and subsequent to the identification of the one or more action components, performing an operation on the object hosted on the collaboration system, the operation including the classification level change for the electronic document from an old classification level to a new classification level.

In various embodiments, the display 1808 provides a graphical output, for example associated with an operating system, user interface, and/or applications of the electronic device 1800 (e.g., a chat user interface, an issue-tracking user interface, an issue-discovery user interface, etc.). In one embodiment, the display 1808 includes one or more sensors and is configured as a touch-sensitive (e.g., single-touch, multi-touch) and/or force-sensitive display to receive inputs from a user. For example, the display 1808 may be integrated with a touch sensor (e.g., a capacitive touch sensor) and/or a force sensor to provide a touch- and/or force-sensitive display. The display 1808 is operably coupled to the processing unit 1802 of the electronic device 1800.

The display 1808 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1808 is positioned beneath and viewable through a cover that forms at least a portion of an enclosure of the electronic device 1800.

In various embodiments, the input devices 1806 may include any suitable components for detecting inputs. Examples of input devices 1806 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1806 may be configured to detect one or more particular types of input and provide a signal (e.g., an input signal) corresponding to the detected input. The signal may be provided, for example, to the processing unit 1802.

As discussed above, in some cases, the input device(s) 1806 include a touch sensor (e.g., a capacitive touch sensor) integrated with the display 1808 to provide a touch-sensitive display. Similarly, in some cases, the input device(s) 1806 include a force sensor (e.g., a capacitive force sensor) integrated with the display 1808 to provide a force-sensitive display.

The output devices 1810 may include any suitable components for providing outputs. Examples of output devices 1810 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 1810 may be configured to receive one or more signals (e.g., an output signal provided by the processing unit 1802) and provide an output corresponding to the signal.

In some cases, input devices 1806 and output devices 1810 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1802 may be operably coupled to the input devices 1806 and the output devices 1810. The processing unit 1802 may be adapted to exchange signals with the input devices 1806 and the output devices 1810. For example, the processing unit 1802 may receive an input signal from an input device 1806 that corresponds to an input detected by the input device 1806. The processing unit 1802 may interpret the received input signal to determine whether to provide and/or change one or more outputs in response to the input signal. The processing unit 1802 may then send an output signal to one or more of the output devices 1810, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

1. A computer-implemented method for automated data classification within a collaboration system, the method comprising:
causing display of a rule builder graphical user interface of a frontend of the collaboration system, the rule builder graphical user interface including a rule component selection user element;
in response to receiving a selection of the rule component selection user element for an automation rule, causing display of a trigger selection window for a set of candidate trigger components for the automation rule, the set of candidate trigger components including a classification trigger component;
subsequent to receiving a first input of the rule builder graphical user interface selecting the classification trigger component for the automation rule, causing display of a classification trigger modification window that includes at least an input field to indicate a classification level change for an electronic document associated with the classification trigger component;
subsequent to a user input to the input field indicating the classification level change, causing display of a first one or more graphical elements representing the classification trigger component in a proposed automation rule flow;
in response to receiving a second input of the rule builder graphical user interface selecting one or more action components for the automation rule, causing display of a second one or more graphical elements representing the one or more action components in the proposed automation rule flow; and
generating a service on the collaboration system that performs an operation on an object in response to an event satisfying a criteria of the classification trigger component of the automation rule, the operation corresponding to the one or more action components.

2. The computer-implemented method of claim 1, wherein the electronic document is hosted on a first collaboration platform and owned by an authenticated user, and the service further performs:
obtaining a permission profile of a second user that owns the object, the object hosted on a second collaboration platform; and
in response to verifying the permission profile of the second user, performing the operation on the object at the second collaboration platform.

3. The computer-implemented method of claim 1, wherein:
the classification trigger component is configured to utilize a generative output engine to determine that the event satisfies the criteria of the classification trigger component, the determination based at least in part on content extracted from the electronic document.

4. The computer-implemented method of claim 1, wherein:
the electronic document is associated with a document management platform of the collaboration system; and
the classification level change is from an old classification level to a new classification level, wherein the old classification level comprises one of a restricted, a protected, a confidential, an internal, or a public classification level, and the new classification level comprises a different one of the restricted, the protected, the confidential, the internal, or the public classification level.

5. The computer-implemented method of claim 1, wherein:
the classification trigger component is associated with the event at a first collaboration platform of the collaboration system; and
the one or more action components are associated with a second collaboration platform of the collaboration system, the object hosted on the second collaboration platform.

6. A computer-implemented method for automated data classification within a collaboration system, the method comprising:
monitoring a set of event data of the collaboration system according to a classification trigger component of an automation rule;
in response to monitoring the set of event data, receiving an event message associated with a classification level change for an electronic document from an old classification level to a new classification level, the electronic document associated with an object hosted on the collaboration system;
in response to a determination that the classification level change satisfies a criteria of the classification trigger component, identifying one or more action components of the automation rule; and
subsequent to the identification of the one or more action components, performing an operation on the object hosted on the collaboration system, the operation corresponding to the one or more action components.

7. The computer-implemented method of claim 6, further comprising:
in response to receiving the event message, extracting content from the electronic document;
generating a content classification prompt comprising the extracted content, an indication of the new classification level, and one or more exemplary content-classification pairs;
providing the content classification prompt to a generative output engine;
obtaining, from the generative output engine, a generative response that indicates that the electronic document is associated with the new classification level; and
determining, based at least in part on the generative response that indicates the new classification level, that the classification level change satisfies the criteria of the classification trigger component.

8. The computer-implemented method of claim 7, wherein the event message indicates the new classification level for the electronic document, the computer-implemented method further comprising:
in response to determining that the new classification level indicated by the event message matches the new classification level indicated by the generative response, determining to proceed to perform the operation.

9. The computer-implemented method of claim 7, wherein the event message indicates the new classification level for the electronic document, the method further comprising:
in response to determining that the new classification level indicated by the event message is inconsistent with the new classification level indicated by the generative response, performing a classification review operation prior to performing the operation on the object hosted on the collaboration system.

10. The computer-implemented method of claim 6, further comprising:
subsequent to the identification of the one or more action components, determining whether the classification level change is from a less restrictive classification level to a relatively more restrictive classification level;
in response to determining that the classification level change is from the less restrictive classification level to the relatively more restrictive classification level, proceeding to perform the operation on the object hosted on the collaboration system; and
in response to determining that the classification level change is from a more restrictive classification level to a relatively less restrictive classification level, transmitting a message requesting authorization to perform the operation and, in response to receiving the authorization, proceeding to perform the operation on the object hosted on the collaboration system.

11. The computer-implemented method of claim 6, further comprising:
identifying, in the electronic document, first content of the electronic document and a link to another content item;
extracting second content from the another content item; and
determining that the criteria of the classification trigger component is satisfied based at least in part on the first content and the second content.

12. The computer-implemented method of claim 11, wherein:
the electronic document comprises an issue item of an issue tracking platform of the collaboration system; and
the another content item comprises a page of a documentation platform of the collaboration system, the link to the another content item comprising the link to the page of the documentation platform.

13. A computer-implemented method for automated data classification within a collaboration system, the method comprising:
causing display of a rule builder graphical user interface of a frontend of the collaboration system, the rule builder graphical user interface including a rule component selection user element;
in response to receiving a first input of the rule builder graphical user interface selecting a trigger component for an automation rule, causing display of a first one or more graphical elements representing the trigger component in a proposed automation rule flow;
in response to receiving a selection of the rule component selection user element for the automation rule, causing display of a selection window for a set of candidate action components for the automation rule, the set of candidate action components including a classification action component;
subsequent to receiving a second input of the rule builder graphical user interface selecting the classification action component for the automation rule, causing display of a classification action modification window that includes at least an input field to indicate a classification level for an electronic document associated with the classification action component;
subsequent to a user input to the input field indicating the classification level, causing display of a second one or more graphical elements representing the classification action component in the proposed automation rule flow; and
generating a service on the collaboration system that performs an operation on an object in response to an event satisfying a criteria of the trigger component of the automation rule, the operation corresponding to the classification action component.

14. The computer-implemented method of claim 13, wherein the electronic document is hosted on a first collaboration platform of the collaboration system and owned by an authenticated user, and the service further performs:
obtaining a permission profile of a second user that owns the object, the object hosted on a second collaboration platform; and
in response to verifying the permission profile of the second user, performing the operation on the object at the second collaboration platform.

15. The computer-implemented method of claim 13, wherein:
the operation corresponding to the classification action component comprises modifying one or more permissions for the object.

16. The computer-implemented method of claim 13, wherein:
the object is associated with a page or a document of a documentation platform of the collaboration system, or an issue or a task of an issue tracking platform of the collaboration system.

17. A computer-implemented method for automated data classification within a collaboration system, the method comprising:
monitoring a set of event data of the collaboration system according to a trigger component of an automation rule;
in response to monitoring the set of event data, receiving an event message that satisfies a criteria of the trigger component for an electronic document associated with an object hosted on the collaboration system;
subsequent to receiving the event message, identifying one or more action components of the automation rule, the one or more action components including a classification action component that is associated with a classification level change; and
subsequent to the identification of the one or more action components, performing an operation on the object hosted on the collaboration system, the operation including the classification level change for the electronic document from an old classification level to a new classification level.

18. The computer-implemented method of claim 17, further comprising:
subsequent to the identification of the one or more action components, determining whether the classification level change is from a less restrictive classification level to a relatively more restrictive classification level;
in response to determining that the classification level change is from the less restrictive classification level to the relatively more restrictive classification level, proceeding to perform the operation on the object hosted on the collaboration system; and
in response to determining that the classification level change is from a more restrictive classification level to a relatively less restrictive classification level, transmitting a message requesting authorization to perform the operation and, in response to receiving the authorization, proceeding to perform the operation on the object hosted on the collaboration system.

19. The computer-implemented method of claim 17, further comprising:
in response to a determination that the classification action component operates on the object, obtaining a permission profile of a second user that owns the object, the object hosted on a second collaboration platform of the collaboration system;
verifying the permission profile with respect to the operation to be performed on the object hosted by the second collaboration platform; and
in response to verifying the permission profile of the second user, performing the operation on the object at the second collaboration platform.

20. The computer-implemented method of claim 17, wherein the operation on the object that includes the classification level change comprises:
transmitting, to a security service, a message requesting the classification level change for the electronic document; and
in response to the transmitted message, receiving an acknowledgment message indicating that the classification level change has been performed at the security service.
